(19) United States
(12) Patent Application Publication
(10) Pub. No.: US 2019/0056917 A1
(43) Pub. Date: Feb. 21, 2019

(54) SYSTEMS, MEDIA, AND METHODS FOR CONDUCTING INTELLIGENT WEB PRESENCE REDESIGN

(71) Applicant: CML Media Corp., Irvine, CA (US)

(72) Inventors: Eric George BERNAL, Laguna Niguel, CA (US); Scott Eric BERNAL, Irvine, CA (US); Cary Michael LEVINE, Coto de Caza, CA (US); Thomas William RICH, Newport Coast, CA (US); Shanket Rajendra PATEL, Anaheim Hills, CA (US)

(21) Appl. No.: 16/104,624

(22) Filed: Aug. 17, 2018

Related U.S. Application Data
(60) Provisional application No. 62/547,593, filed on Aug. 18, 2017.

(51) Int. Cl. G06F 8/33; G06F 8/36; G06F 17/30; G06F 8/38; G06F 15/18

(52) U.S. Cl. CPC G06F 8/33; G06F 8/36; G06F 15/18; G06F 17/30867; G06F 8/38; G06F 17/3089

(57) ABSTRACT

Disclosed are systems, media, and methods for automatically and intelligently redesigning a web presence by: ingesting files of an existing web site; extracting content from the ingested files; surveying a user for user preferences; determining a style package based on the user preferences; selecting a web site skeleton from a plurality of preconfigured web site skeletons based on the user preferences, the web site skeleton having a plurality of hierarchical blocks; applying a machine learning system to rank the extracted content; populating the content into the hierarchy of blocks based on the rank; automatically generating a redesigned web site by applying the style package to the populated web site skeleton; and providing an interface allowing the user to edit the style package, the content, and the web site skeleton.

### CROSS-REFERENCE

This application claims the benefit of the U.S. Provisional Application No. 62/547,593, filed Aug. 18, 2017, which application is incorporated herein by reference.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

A web site has become an essential online platform for a business owner to showcase their commercial products, enable online shopping for their customers, deliver up-to-date messages to their customers, attract attention from potential investors or other third-part agencies, and present various features to different audience.

### SUMMARY OF THE INVENTION

Existing web sites for business owners are mostly created using expensive so-called customized services, very limited commercial tools, and/or do-it-yourself (DIY) software. However, the existing web sites are not optimally designed for fulfilling their key functionalities. As a result, the web sites are often incapable of presenting values that the business owners consider as essential or critical, unable to emphasize differences of their brand(s) and products with those of their competitors, lack of features for reaching out to different audience and attracts them back to the web sites, and unable to provide clear objectives to measure success of their products. Further, limitations or disadvantages of the existing business web sites include outdated user experience, unsatisfactory quality of web site design, lack of DIY functionality for the web site users, and insufficient presence of customer service on the web site.

Softwares or tools may be used for designing customized web sites for business owners, optionally, based on an existing version of the web site. Unfortunately, current web site design tools, including those online resources, are unable to address the problems or disadvantages of the existing web sites. In addition, the current web site design tools does not allow a user to conveniently evaluate their existing web site based on various categories such as search engine optimization (SEO) value, mobile compatibility, usability, social activity. Further, the current web site design tools fail to provide customized design features based on the customer base of the business and/or the different brands that inspire or motivate the business. Moreover, existing tools are unable to emphasize values of the business that differentiate it from competitors in a web site design. Yet further, current web design services fails to provide a simple and intuitive user interface, allow automated social media configurations for the business owners or users, provide automatic reaching out to the clients, or provide design capabilities supported by artificial intelligence algorithms.

The systems, methods, and media disclosed herein enable web site design/rebuilding which overcome the problems associated with existing business web sites and current web design tools. For example, the systems, methods, and media disclosed herein provide an automated evaluation and analysis of an existing web site for the business owner or user based on very specific categories such as SEO, mobile compatibility, usability, and social activities so that a clear objective for web site redesign and evaluation of the redesign can be obtained. In addition to that, a simple, easy to use, and intuitive user interface is enabled herein to gather basic information from the user and gauge his or her style preferences. Such preferences automatically combine colors, visual effects, font, backgrounds, and animations to maximize characteristics of the web site. Thus, the web redesign along with user customization herein is convenient, time-saving, and cost-efficient. Further, in combination with the style preferences of the user, the systems, methods, and media disclosed herein also allow the user to select brands and personas so that their attributes may facilitate further tailoring of the web site to be redesigned. Furthermore, the systems, methods, and media herein are capable of intelligently extracting content from the user's existing web site and automatically using it in the redesign. More importantly, artificial intelligence algorithms are utilized herein to generate additional information/patterns based on the extracted content in order to optimize functionalities of the redesigned web site and make it uniquely appealing to the targeted audience.

In one aspect, disclosed herein are computer-implemented systems comprising: a digital processing device comprising: at least one processor, an operating system configured to perform executable instructions, a memory, and a computer program including instructions executable by the digital processing device to create an intelligent web presence redesign application comprising: a software module for ingesting files of an existing web site; a software module for extracting content from the ingested files; a software module for surveying a user for user preferences to determine a style package and select a web site skeleton from a plurality of preconfigured web site skeletons, the web site skeleton having a plurality of hierarchical blocks; a software module for applying a machine learning system to rank the extracted content and populating the content into the hierarchy of blocks based on the rank; a software module for automatically generating a redesigned web site by applying the style package to the populated web site skeleton; and a software module for providing an interface allowing the user to edit the style package, the content, and the web site skeleton. In some embodiments, the software module for ingesting files of an existing web site allows the user to input a URL for the existing web site. In some embodiments, the software module for extracting the content from the ingested files utilizes a site map of the existing web site. In some embodiments, the software module for extracting the content from the ingested files utilizes a navigation menu of the existing web site. In some embodiments, the software module for extracting content from the ingested files filters content by optical character recognition (OCR). In some embodiments, the software module for extracting content from the ingested files filters content by image recognition. In some embodiments, the application further comprises a software module for analyzing the extracted content to generate a score card for the content. In further embodiments, the score card comprises scores for search engine optimization (SEO), mobile compatibility, usability, social media utilization, or a combination thereof. In some embodiments, the user preferences comprise at least one brand admired by owner of the existing web site. In further embodiments, the at least one brand is associated with a preconfigured amount of content, amount of color, amount of negative space, font style, or a combination thereof. In some embodiments, the user preferences comprise at least one persona selected by the owner of the existing web site as reflective of current users. In further embodiments, the at least one persona is associated with preconfigured demographics, psychographics, words, value propositions, or a combination thereof. In some embodiments, the style package comprises: effects, fonts, images, videos, backgrounds, colors, animations, or a combination thereof. In some embodiments, the user preferences are, at least in part, surveyed via a user dashboard interface. In some embodiments, the software module for applying a machine learning system to rank the extracted content utilizes a process comprising: removing HTML tags from the content; identifying keywords, keyphrases, or both keywords and keyphrases in the content; creating a plurality of patterns based on the keywords, keyphrases, or both keywords and keyphrases; and assigning a rank to each pattern. In some embodiments, the software module for populating the content into the hierarchy of blocks utilizes a process comprising: creating a hierarchy of temporary pages; populating each temporary page with content to generate a non-temporary page; and deleting each corresponding temporary page from the hierarchy. In some embodiments, the application further comprises a software module for configuring automated social media activity. In further embodiments, the software module for configuring automated social media activity allows the user to configure a type of content and a frequency of activity. In still further embodiments, the software module for configuring automated social media activity presents a calendar schedule of automated social media activity. In some embodiments, the software module for automatically generating a redesigned web site generates multiple versions of the web site, wherein at least one version is a mobile version. In some embodiments, the interface allowing the user to edit the style package, the content, and the web site skeleton comprises tools for previewing the redesigned web site on a plurality of devices.

In another aspect, disclosed herein are non-transitory computer-readable storage media encoded with a computer program including instructions executable by a processor to create an intelligent web presence redesign application comprising: a software module for ingesting files of an existing web site; a software module for extracting content from the ingested files; a software module for surveying a user for user preferences to determine a style package and select a web site skeleton from a plurality of preconfigured web site skeletons, the web site skeleton having a plurality of hierarchical blocks; a software module for applying a machine learning system to rank the extracted content and populating the content into the hierarchy of blocks based on the rank; a software module for automatically generating a redesigned web site by applying the style package to the populated web site skeleton; and a software module for providing an interface allowing the user to edit the style package, the content, and the web site skeleton. In some embodiments, the software module for ingesting files of an existing web site allows the user to input a URL for the existing web site. In some embodiments, the software module for extracting the content from the ingested files utilizes a site map of the existing web site. In some embodiments, the software module for extracting the content from the ingested files utilizes a navigation menu of the existing web site. In some embodiments, the software module for extracting content from the ingested files filters content by optical character recognition (OCR). In some embodiments, the software module for extracting content from the ingested files filters content by image recognition. In some embodiments, the application further comprises a software module for analyzing the extracted content to generate a score card for the content. In further embodiments, the score card comprises scores for search engine optimization (SEO), mobile compatibility, usability, social media utilization, or a combination thereof. In some embodiments, the user preferences comprise at least one brand admired by owner of the existing web site. In further embodiments, the at least one brand is associated with a preconfigured amount of content, amount of color, amount of negative space, font style, or a combination thereof. In some embodiments, the user preferences comprise at least one persona selected by the owner of the existing web site as reflective of current users. In further embodiments, the at least one persona is associated with preconfigured demographics, psychographics, words, value propositions, or a combination thereof. In some embodiments, the style package comprises: effects, fonts, images, videos, backgrounds, colors, animations, or a combination thereof. In some embodiments, the user preferences are, at least in part, surveyed via a user dashboard interface. In some embodiments, the software module for applying a machine learning system to rank the extracted content utilizes a process comprising: removing HTML tags from the content; identifying keywords, keyphrases, or both keywords and keyphrases in the content; creating a plurality of patterns based on the keywords, keyphrases, or both keywords and keyphrases; and assigning a rank to each pattern. In some embodiments, the software module for populating the content into the hierarchy of blocks utilizes a process comprising: creating a hierarchy of temporary pages; populating each temporary page with content to generate a non-temporary page; and deleting each corresponding temporary page from the hierarchy. In some embodiments, the application further comprises a software module for configuring automated social media activity. In further embodiments, the software module for configuring automated social media activity allows the user to configure a type of content and a frequency of activity. In still further embodiments, the software module for configuring automated social media activity presents a calendar schedule of automated social media activity. In some embodiments, the software module for automatically generating a redesigned web site generates multiple versions of the web site, wherein at least one version is a mobile version. In some embodiments, the interface allowing the user to edit the style package, the content, and the web site skeleton comprises tools for previewing the redesigned web site on a plurality of devices.

In yet another aspect, disclosed herein are computer-implemented methods for automated intelligent web presence redesign comprising: ingesting files of an existing web site; extracting content from the ingested files; surveying a user for user preferences; determining a style package based on the user preferences; selecting a web site skeleton from a plurality of preconfigured web site skeletons based on the user preferences, the web site skeleton having a plurality of hierarchical blocks; applying a machine learning system to rank the extracted content; populating the content into the hierarchy of blocks based on the rank; automatically generating a redesigned web site by applying the style package to the populated web site skeleton; and providing an interface allowing the user to edit the style package, the content, and the web site skeleton. In some embodiments, the existing web site is identified by a user inputting a URL. In some embodiments, the extracting the content from the ingested files utilizes a site map of the existing web site. In some embodiments, the extracting the content from the ingested files utilizes a navigation menu of the existing web site. In some embodiments, the extracting content from the ingested files comprises filtering content by optical character recognition (OCR). In some embodiments, the extracting content from the ingested files comprises filtering content by image recognition. In some embodiments, the method further comprises analyzing the extracted content to generate a score card for the content. In further embodiments, the score card comprises scores for search engine optimization (SEO), mobile compatibility, usability, social media utilization, or a combination thereof. In some embodiments, the user preferences comprise at least one brand admired by owner of the existing web site. In further embodiments, the at least one brand is associated with a preconfigured amount of content, amount of color, amount of negative space, font style, or a combination thereof. In some embodiments, the user preferences comprise at least one persona selected by the owner of the existing web site as reflective of current users. In further embodiments, the at least one persona is associated with preconfigured demographics, psychographics, words, value propositions, or a combination thereof. In some embodiments, the style package comprises: effects, fonts, images, videos, backgrounds, colors, animations, or a combination thereof. In some embodiments, the user preferences are, at least in part, surveyed via a user dashboard interface. In some embodiments, the applying a machine learning system to rank the extracted content comprises: removing HTML tags from the content; identifying keywords, keyphrases, or both keywords and keyphrases in the content; creating a plurality of patterns based on the keywords, keyphrases, or both keywords and keyphrases; and assigning a rank to each pattern. In some embodiments, the populating the content into the hierarchy of blocks comprises: creating a hierarchy of temporary pages; populating each temporary page with content to generate a non-temporary page; and deleting each corresponding temporary page from the hierarchy. In some embodiments, the method further comprises providing an interface for allowing the user to configure automated social media activity. In further embodiments, the interface for allowing the user to configure automated social media activity allows the user to configure a type of content and a frequency of activity. In still further embodiments, the interface for allowing the user to configure automated social media activity presents a calendar schedule of automated social media activity. In some embodiments, the automatically generating a redesigned web site comprises generating multiple versions of the web site, wherein at least one version is a mobile version. In some embodiments, the method further comprises providing a preview of the redesigned web site on a plurality of devices.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting exemplary embodiment of the style package of the systems, methods, and media disclosed herein;

FIG. 2 shows a non-limiting exemplary embodiment of the style packages, the personas, brands, and their relationships of the systems, methods, and media disclosed herein;

FIG. 3 shows a non-limiting exemplary embodiment of applying a style package to bare-bones information provided by the user using the systems, methods, and media disclosed herein;

FIG. 4 shows a non-limiting exemplary embodiment of an interface of the systems, methods, and media disclosed herein; in this case, a user interface that allows a user to start an intelligent web site redesign process or view related information;

FIG. 5 shows a non-limiting exemplary embodiment of a user interface of the systems, methods, and media disclosed herein; in this case, a user interface that allows a user to enter a business name and a web site URL for web site redesign;

FIG. 6 shows a non-limiting exemplary embodiment of a user interface of the systems, methods, and media disclosed herein; in this case, a user interface that allows a user to view a summary of analysis of the entered web site in FIG. 5;

FIG. 7 shows a non-limiting exemplary embodiment of a user interface of the systems, methods, and media disclosed herein; in this case, a user interface that allows a user to view detailed analysis of aspects related to search engine optimization (SEO) of the entered web site;

FIG. 8 shows a non-limiting exemplary embodiment of a user interface of the systems, methods, and media disclosed herein; in this case, a user interface that allows a user to view detailed analysis of aspects related to access from portable devices of the entered web site;

FIG. 9 shows a non-limiting exemplary embodiment of a user interface of the systems, methods, and media disclosed herein; in this case, a user interface that allows a user to view detailed analysis of aspects related to usability of the entered web site;

FIG. 10 shows a non-limiting exemplary embodiment of a user interface of the systems, methods, and media disclosed herein; in this case, a user interface that allows a user to view detailed analysis of aspects related to linkage to different social media web sites of the entered web site;

FIG. 11 shows a non-limiting exemplary embodiment of a user interface of the systems, methods, and media disclosed herein; in this case, a dashboard that allows a user to edit or input information related to different exemplary categories that can be used for web site redesign;

FIG. 12 shows a non-limiting exemplary embodiment of a user interface of the systems, methods, and media disclosed herein; in this case, a user interface that allows a user to edit or input colors that can be used for web site redesign;

FIG. 13 shows a non-limiting exemplary embodiment of a user interface of the systems, methods, and media disclosed herein; in this case, a user interface that allows a user to edit or select font package(s) that can be used for web site redesign;

FIG. 14 shows a non-limiting exemplary embodiment of a user interface of the systems, methods, and media disclosed herein; in this case, a user interface that allows a user to select one or more personas that represent the customer base for the web site to be redesigned;

FIG. 15 shows a non-limiting exemplary embodiment of a user interface of the systems, methods, and media disclosed herein; in this case, a user interface that allows a user to select one or more brands that inspires the web site to be redesigned;

FIG. 16 shows a non-limiting exemplary embodiment of a user interface of the systems, methods, and media disclosed herein; in this case, a user interface that allows a user to select one or more images from different categories of images for the web site to be redesigned;

FIG. 17 shows a non-limiting exemplary embodiment of a user interface of the systems, methods, and media disclosed herein; in this case, a user interface that allows a user to select one or more video from different categories of videos for the web site to be redesigned;

FIG. 18 shows a non-limiting exemplary embodiment of a user interface of the systems, methods, and media disclosed herein; in this case, a user interface that allows a user to select or enter one or more aspects to be presented on the web site to be redesigned in order to differentiate from other competitor web sites;

FIG. 19 shows a non-limiting exemplary embodiment of a user interface of the systems, methods, and media disclosed herein; in this case, a user interface that allows a user to enter information of team member(s) for the web site to be redesigned;

FIG. 20 shows a non-limiting exemplary embodiment of a user interface of the systems, methods, and media disclosed herein; in this case, a user interface that allows a user to enter testimonial(s) for the web site to be redesigned;

FIGS. 21-22 show a non-limiting flow chart of the systems, methods, and media disclosed herein;

FIG. 23 shows a non-limiting flow chart of the systems, methods, and media disclosed herein including a machine learning system;

FIG. 24 shows a non-limiting exemplary embodiment of a user interface of the systems, methods, and media disclosed herein; in this case, a user interface that allows a user to select one or more categories of content, optionally from the user's web site, to be presented on a social media interface;

FIG. 25 shows a non-limiting exemplary embodiment of a user interface of the systems, methods, and media disclosed herein; in this case, a user interface that allows a user to select a frequency for posting one or more categories of content on a social media interface;

FIG. 26 shows a non-limiting exemplary embodiment of a user interface of the systems, methods, and media disclosed herein; in this case, a user interface that allows a user to select different time(s) for posting one or more categories of content on a social media interface;

FIG. 27 shows a non-limiting exemplary embodiment of a user interface of the systems, methods, and media disclosed herein; in this case, a user interface that suggests and allows a user to edit a posting schedule for posting one or more categories of content on a social media interface;

FIG. 28 shows a non-limiting exemplary embodiment of a user interface of the systems, methods, and media disclosed herein; in this case, a user interface that allows a user to view a posting schedule for posting one or more categories of content on a social media interface;

FIG. 29 shows a non-limiting schematic diagram of a digital processing device; in this case, a device with one or more CPUs, a memory, a communication interface, and a display;

FIG. 30 shows a non-limiting schematic diagram of a web/mobile application provision system; in this case, a system providing browser-based and/or native mobile user interfaces;

FIG. 31 shows a non-limiting schematic diagram of a cloud-based web/mobile application provision system; in this case, a system comprising an elastically load balanced, auto-scaling web server and application server resources as well synchronously replicated databases; and

FIGS. 32-36 show a non-limiting exemplary embodiment of a web site skeleton (e.g., template) disclosed herein; in this case, a modular web site skeleton comprising blocks and wherein a style package has not yet been applied to the web site skeleton.

### DETAILED DESCRIPTION OF THE INVENTION

Existing web sites for business owners are mostly created using expensive so-called customized services, very limited commercial tools, and/or do-it-yourself (DIY) software. However, the existing web sites are not optimally designed for fulfilling their key functionalities. As a result, the web sites are often incapable of presenting values that the business owners consider as essential or critical, unable to emphasize differences of their brand(s) and products with those of their competitors, lack of features for reaching out to different audience and attracts them back to the web sites, and unable to provide clear objectives to measure success of their products. Further, limitations or disadvantages of the existing business web sites include outdated user experience, unsatisfactory quality of web site design, lack of DIY functionality for the web site users, and insufficient presence of customer service on the web site.

Softwares or tools may be used for designing customized web sites for business owners, optionally, based on an existing version of the web site. Unfortunately, current web site design tools, including those online resources, are unable to address the problems or disadvantages of the existing web sites. In addition, the current web site design tools does not allow a user to conveniently evaluate their existing web site based on various categories such as search engine optimization (SEO) value, mobile compatibility, usability, social activity. Further, the current web site design tools fail to provide customized design features based on the customer base of the business and/or the different brands that inspire or motivate the business. Moreover, existing tools are unable to emphasize values of the business that differentiate it from competitors in a web site design. Yet further, current web design services fails to provide a simple and intuitive user interface, allow automated social media configurations for the business owners or users, provide automatic reaching out to the clients, or provide design capabilities supported by artificial intelligence algorithms.

The systems, methods, and media disclosed herein enable web site design/rebuilding which overcome the problems associated with existing business web sites and current web design tools. For example, the systems, methods, and media disclosed herein provide an automated evaluation and analysis of an existing web site for the business owner or user based on very specific categories such as SEO, mobile compatibility, usability, and social activities so that a clear objective for web site redesign and evaluation of the redesign can be obtained. In addition to that, a simple, easy to use, and intuitive user interface is enabled herein to gather basic information from the user and gauge his or her style preferences. Such preferences automatically combine colors, visual effects, font, backgrounds, and animations to maximize characteristics of the web site. Thus, the web redesign along with user customization herein is convenient, time-saving, and cost-efficient. Further, in combination with the style preferences of the user, the systems, methods, and media disclosed herein also allow the user to select brands and personas so that their attributes may facilitate further tailoring of the web site to be redesigned. Furthermore, the systems, methods, and media herein are capable of intelligently extracting content from the user's existing web site and automatically using it in the redesign. More importantly, artificial intelligence algorithms are utilized herein to generate additional information/patterns based on the extracted content in order to optimize functionalities of the redesigned web site and make it uniquely appealing to the targeted audience.

Described herein, in certain embodiments, are computer-implemented systems comprising: a digital processing device comprising: at least one processor, an operating system configured to perform executable instructions, a memory, and a computer program including instructions executable by the digital processing device to create an intelligent web presence redesign application comprising: a software module for ingesting files of an existing web site; a software module for extracting content from the ingested files; a software module for surveying a user for user preferences to determine a style package and select a web site skeleton from a plurality of preconfigured web site skeletons, the web site skeleton having a plurality of hierarchical blocks; a software module for applying a machine learning system to rank the extracted content and populating the content into the hierarchy of blocks based on the rank; a software module for automatically generating a redesigned web site by applying the style package to the populated web site skeleton; and a software module for providing an interface allowing the user to edit the style package, the content, and the web site skeleton.

Also described herein, in certain embodiments, are non-transitory computer-readable storage media encoded with a computer program including instructions executable by a processor to create an intelligent web presence redesign application comprising: a software module for ingesting files of an existing web site; a software module for extracting content from the ingested files; a software module for surveying a user for user preferences to determine a style package and select a web site skeleton from a plurality of preconfigured web site skeletons, the web site skeleton having a plurality of hierarchical blocks; a software module for applying a machine learning system to rank the extracted content and populating the content into the hierarchy of blocks based on the rank; a software module for automatically generating a redesigned web site by applying the style package to the populated web site skeleton; and a software module for providing an interface allowing the user to edit the style package, the content, and the web site skeleton.

Also described herein, in certain embodiments, are computer-implemented methods for automated intelligent web presence redesign comprising: ingesting files of an existing web site; extracting content from the ingested files; surveying a user for user preferences; determining a style package based on the user preferences; selecting a web site skeleton from a plurality of preconfigured web site skeletons based on the user preferences, the web site skeleton having a plurality of hierarchical blocks; applying a machine learning system to rank the extracted content; populating the content into the hierarchy of blocks based on the rank; automatically generating a redesigned web site by applying the style package to the populated web site skeleton; and providing an interface allowing the user to edit the style package, the content, and the web site skeleton.

### Certain Definitions

Unless otherwise defined, all technical terms used herein have the same meaning as commonly understood by one of ordinary skill in the art to which this invention belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 10%, 5%, or 1%, including increments therein.

Overview

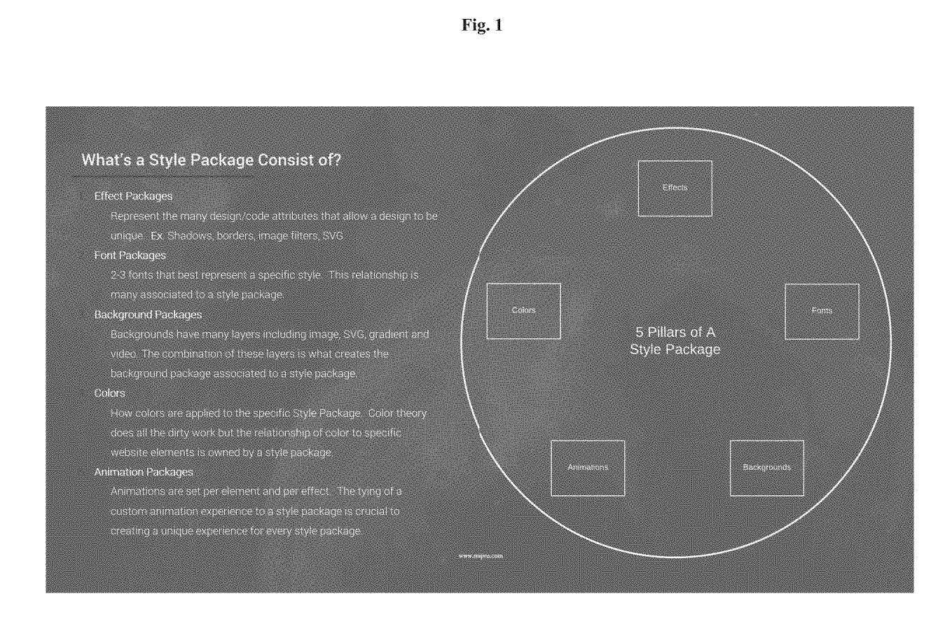

Described herein, in certain embodiments, are computer-implemented systems, methods, and media for intelligent web presence redesign based on an existing web site URL provided by the user or the web site owner. In some cases, the systems, methods, and media may automatically select a style package for the web site redesign based on information of the user or of the existing web site. As an example, information of the user may be obtained from the user's social media accounts and activities. Alternatively, the user may also have the option to manually select a whole style package or manually tailor one or multiple aspects of a selected style package to be applied to the web site to be redesigned. In some cases, the style package is used to set one or more style preferences for the redesigned web site, such as background music, a shade surrounding an image, a theme color, an animation, a slide show, etc. Referring to FIG. 1, in a particular embodiment, the style package includes one or more color, font, background, animation, and effect for each individual element or a combination of element of the web site.

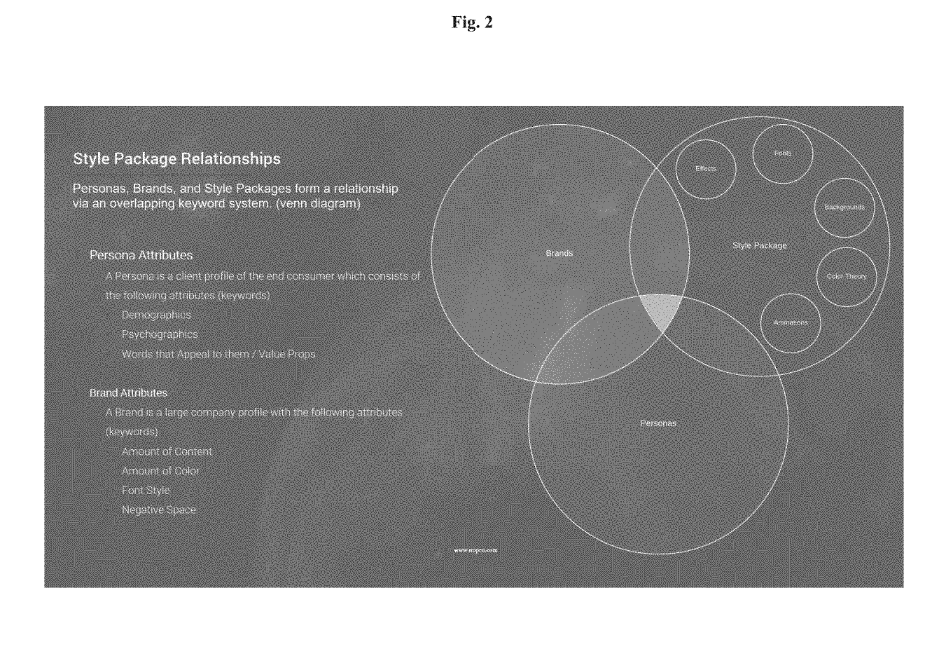

Further, as disclosed herein, a style package may be used in combination with other user preferences to optimize redesign of the user's web site. In some cases, such user preferences include brands that inspire the user in his or her business, and the personas that represent the customer base of the user's business. As shown in FIG. 2, personas, brands, and a style package may form a relationship via an overlapping keyword system. In some cases, the features/keywords in the central overlapped region of the three can be selected for redesigning the web site.

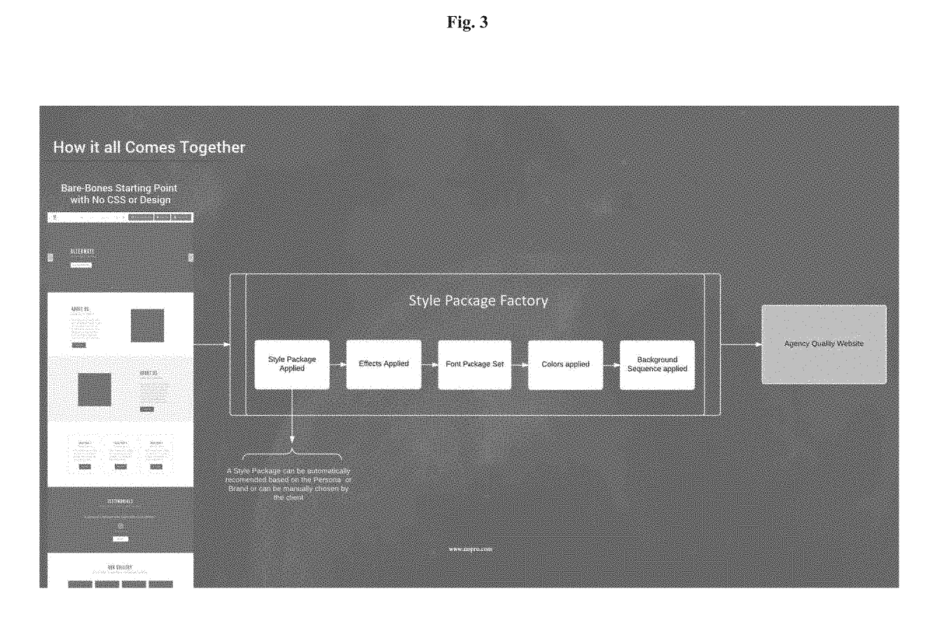

In some cases, intelligent web presence redesign using the systems, methods, and media herein starts with a skeleton layout as shown in FIG. 3. In certain embodiments, the skeleton layout may include user provided information or information automatically extracted from the existing web site. Additionally, the skeleton layout may include information extracted from the social medial accounts provided by the user. In some embodiments, the automatic extraction of content may use an artificial intelligence system to ensure accuracy and reliability with high efficiency. For instances, a particular style package, optionally in combination with other user preferences, is applied to the skeleton layout with one or more of effect, font, color, animation, and background applied simultaneously or in different sequences, and the redesigned web site can presented to the user for review and further edits.

### Ingesting Files

In some embodiments, the systems, media, and methods disclosed herein include a software module for ingesting files or information of an existing web site.

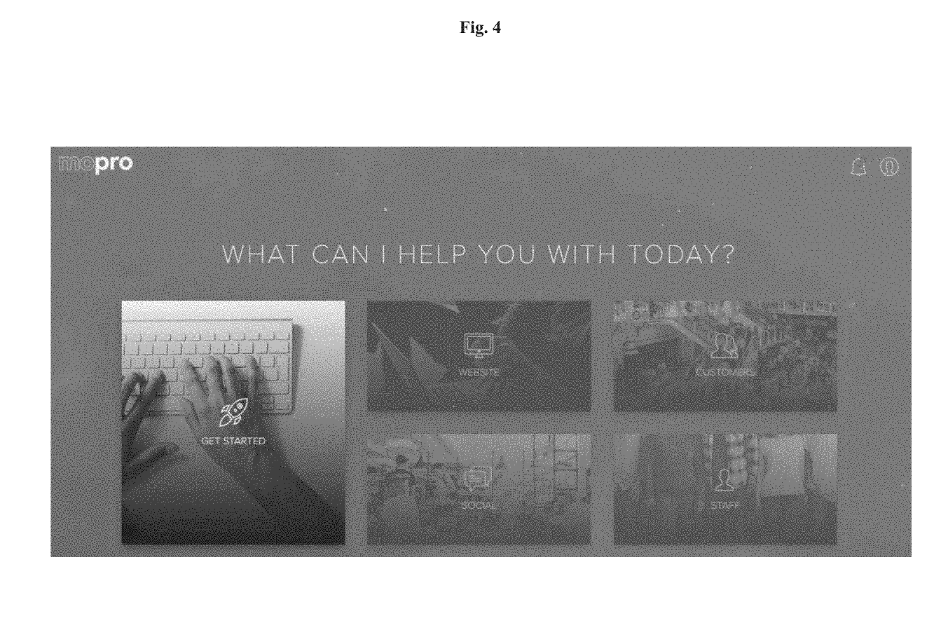

Referring to FIG. 4, in a particular embodiment, a user may start the process of redesigning his or her web site at a user interface via an interaction with the interface. In the same embodiment, the user may also select to view or edit other related information, such as a customer database with customers of his or her web site, business information, and social media account(s) associated with his or her account, the social media activities, or, optionally, the staff member(s) of his or her business.

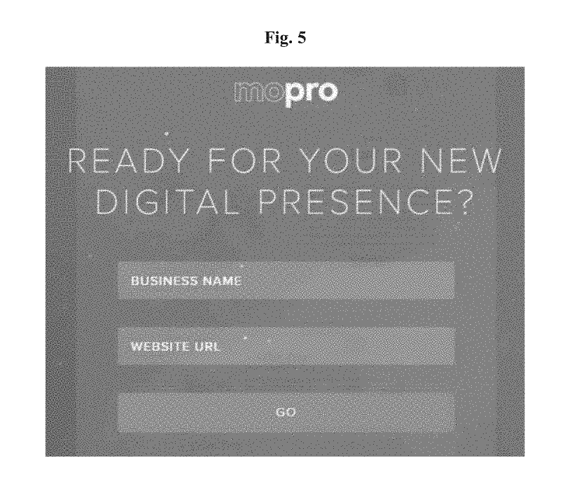

After the user initiates the web site redesign process, as shown in FIG. 4, the user may be directed to an interface to enter the business name and the URL for the web site that needs to be redesigned, as shown in FIG. 5. Optionally, the systems, methods, or media may also design a web site from scratch without a preexisting web site for the user. Alternatively, the systems, methods, or media may also design a web site using design and style preferences from a third-part web site.

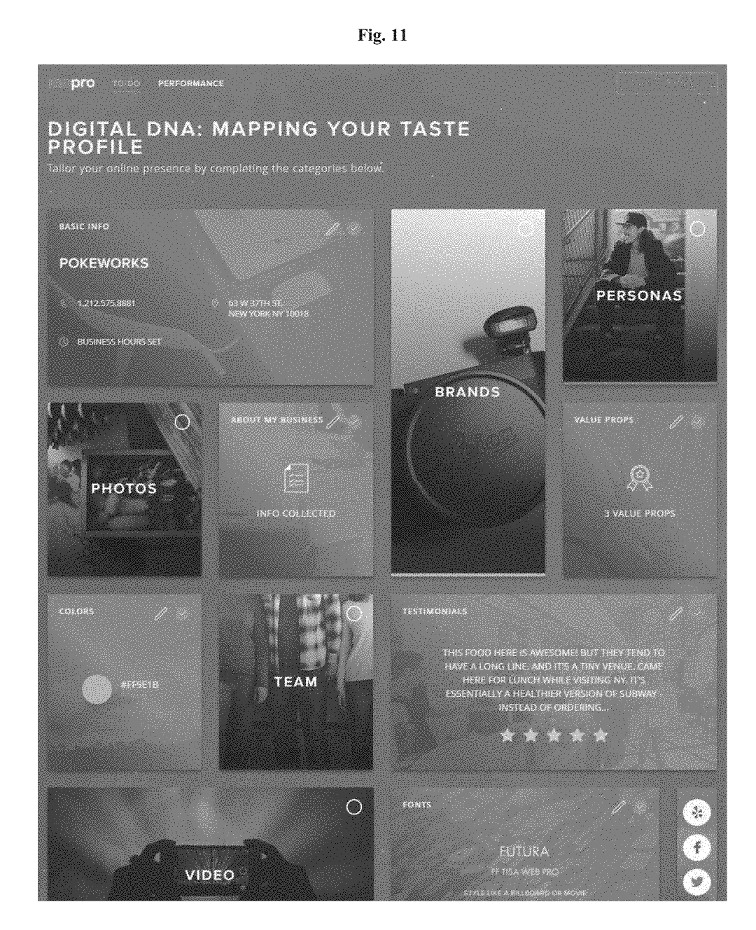

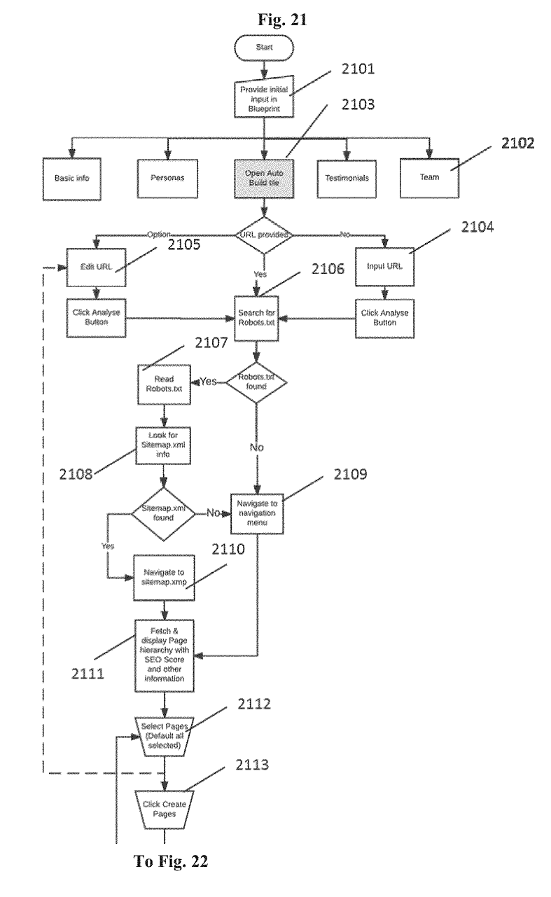

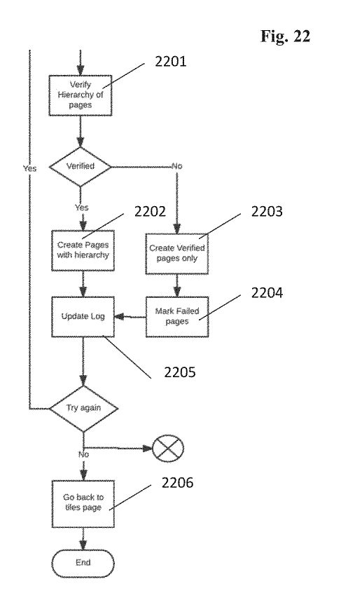

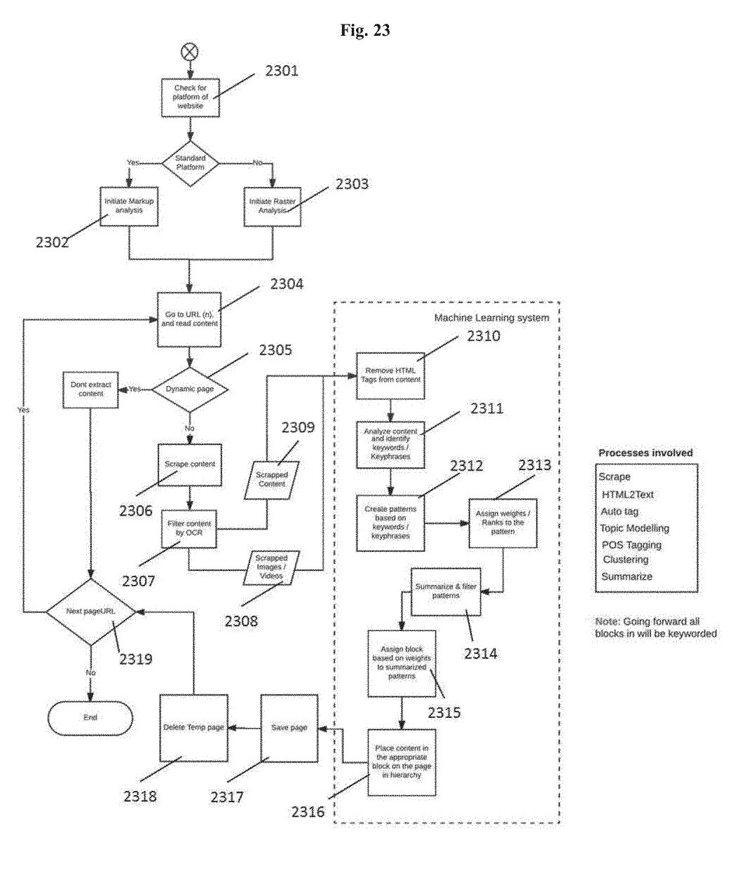

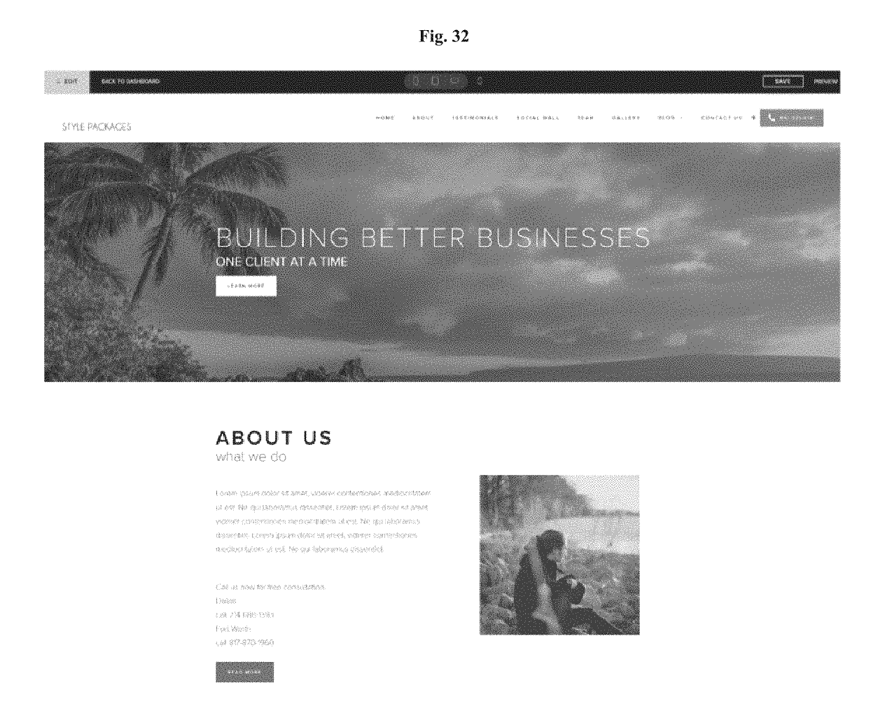

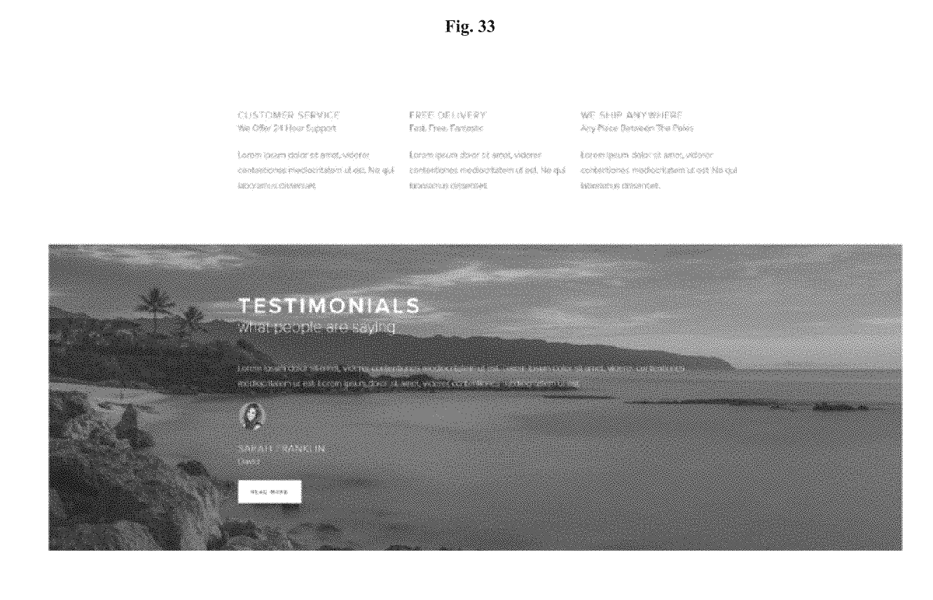

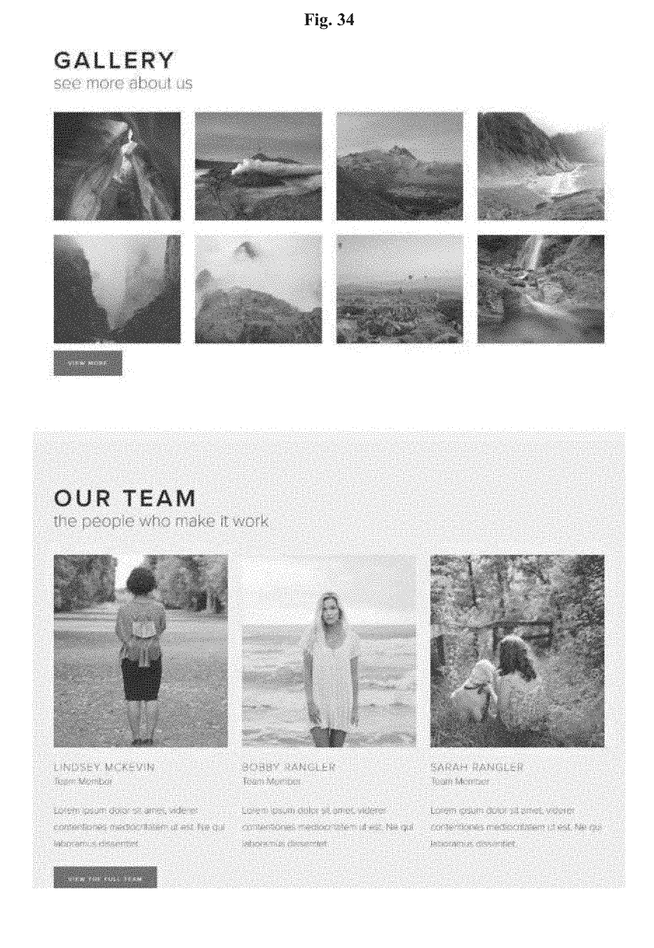

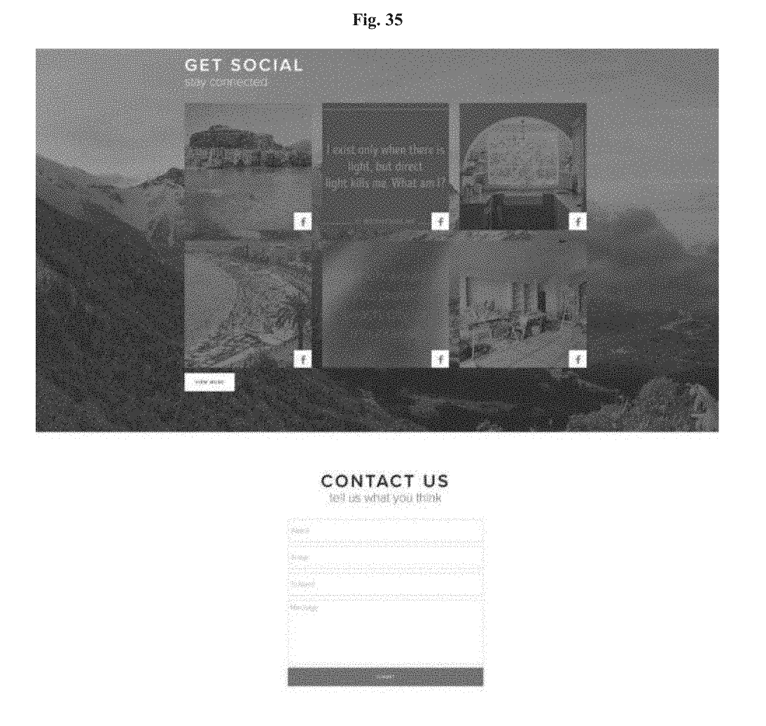

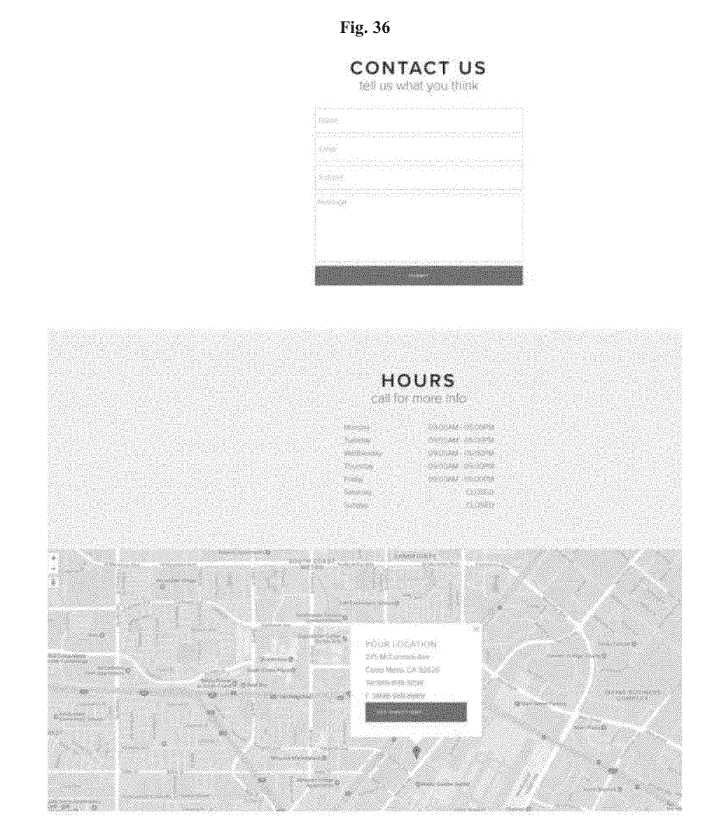

As shown in FIG. 21-22, in a particular embodiment, the user is first prompt to input basic information 2101 after he or she initiates the web site redesign process. Such basic information 2102 may include business information, team, testimonials, personas, brands, or any other related information. In some cases, the systems, methods, or media disclosed herein opens a web site building tile 2103, optionally, a web site skeleton, or a number of temporary web pages. In the same embodiment, the user is prompt to provide a URL of his/her current web site or edit an existing URL 2104. Optionally, the user may click a button at a user interface so that the web site may be analyzed and evaluated. In some cases, such analysis may be based on ingested files and extracted content of the current web site. Similarly, in some cases, the redesign of current web site may also be based on ingested files and the extracted information. More specifically, the ingested files and the extract information may be populated into the web skeleton (as shown in FIGS. 32-36), the dashboard (as shown in FIG. 11), or directly into the redesigned web site. Additionally, the ingested files and the extract information may be fed into machine learning systems for optimizing presence of the information in the redesigned web site. In this particular embodiment, a robots.txt file of the current web site is searched and read 2106-2107 to determine access by search engine robots. In the same embodiment, a sitemap 2108 and/or a navigation menu 2109 are also be searched and read for determination and verification of the hierarchy and categories of content. In further cases, the site map and the navigation menu can be used as a guide for extracting information under specific categories, or for generating key words and/or key phrases for pattern recognition. Such patterns then can be used to build block modulars for the redesigned web site. In some cases, if a sitemap is found 2110, the sitemap is used to fetch and display web page hierarchy with SEO score and other information 2111, optionally, for the purposes of web site analysis and/or web site redesign. In some cases, displayed web pages, optionally from the existing website, may then be selected 2112 to create web pages 2113 of the redesigned website. Referring to FIG. 22, the hierarchy of the created pages are verified 2201 and the web pages are then created with the verified hierarchy 2202. Alternatively, only web pages with verified hierarchy are created 2203 and failed pages are marked 2204, and the systems, methods, and media optionally return to the tiles page 2206.

In some cases, the files that can be ingested may be any file type that can be included on the existing web site. Non-limiting examples may include .html files, .txt files, .js files, .cs files, image files (.jpg files, .gif files, .png files, etc.), video files (.wmv, .mpeg, .avi, .mov, etc.), audio files (.mp3, .aiff, .au, etc.), multimedia elements (interactives, games, tools, etc.), or the like.

Many raster image formats are suitable for ingestion including, by way of non-limiting examples, Joint Photographic Experts Group (JPEG), JPEG 2000, Exchangeable image file format (EXIF), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), wireless bitmap (WBMP), and WebP. Many vector image formats are suitable for ingestion including, by way of non-limiting examples, CGM and SWF.

Many audio formats are suitable for ingestion including, by way of non-limiting examples, MP3, WAV, AIFF, AU, Apple® Lossless, MPEG-4, Windows Media®, Vorbis, AAC, and Real Audio

Many video formats are suitable for ingestion including, by way of non-limiting examples, Windows® Media Video (WMV), Windows® Media®, Motion Picture Experts Group (MPEG), Audio Video Interleave (AVI), Apple® QuickTime®, RealMedia®, Flash Video, Motion JPEG (M-JPEG), WebM, and Advanced Video Coding High Definition (AVCHD).

Many multimedia formats are suitable for ingestion including, by way of non-limiting examples, Adobe® Flash®, Apple® QuickTime®, Microsoft® Silverlight®, Java™, HTML 5, XHTML 5, and Unity®.

### Extracting Content

In some embodiments, the systems, methods, and media disclosed herein include a software module for extracting content from the ingested files. In some cases, extraction of the content utilizes a robot.txt file or the like of the existing web site. In some cases, extracting the content from the ingested files utilizes a site map of the existing web site. In some cases, extracting the content from the ingested files utilizes a navigation menu of the existing web site. In some cases, extracting content from the ingested files filters content by optical character recognition (OCR). In some cases, extracting content from the ingested files filters content by image recognition. In some cases, extracting the content from the ingested files utilizes a machine learning system, a pattern recognition algorithm, an artificial intelligence algorithm, a deep learning algorithm, or the like.

In some cases, extracting content comprises one or more different processing procedures of the content. Nonlimiting examples of extracting content includes: reading content, searching in content, organizing content, summarizing content, sampling content, filtering content, removing content, scrapping content, pattern recognition, interpreting content, modeling content, clustering content, or a combination thereof.

Referring to FIG. 23, in a particular embodiment, content of the URL provided by the user is read and scrapped for information automatically, optionally with a machine learning system. In this embodiment, the systems, methods, and media herein automatically check for the platform used on the web site provided by the user 2301. Based on the platform determined herein, mark-up analysis 2302 and/or raster analysis 2303 may be used to analyze data of the existing web site before extracting content from the URL. In some cases, the initial analysis may obtain information of a webpage or content therewithin with respect to its importance, quality, or relevance to the existing web site, an existing webpage of the web site, or the web site to be redesigned. In some cases, the text, images, and information of other forms are analyzed to determine if such information should be included in the redesigned website, which block(s) should it be included in, and where should it be positioned in the hierarchy of block modulars. For example, text may be analyzed based on its font size, color, location on the web page, or other related aspects to determine if it is regarded as prominent or high priority information. Further, the text may be analyzed for quality of its content, such as how detailed it is, how concise it is, is it useful for a certain block modular, etc, optionally to determine if it should be included in the redesigned website Similarly, an image, a video, or other files may be analyzed by a computer vision algorithm or other algorithms to determine its importance or relevance to certain categories. For example, an image may be a picture of a product, a testimonial, or a team member, so that it may be placed into corresponding block modular(s). In the same embodiment, content are read 2304 and scrapped 2306 from the given URL if the web page is not dynamic 2305. In some cases, scrapping content 2306 includes but is not limited to one or more of: removing html tags from content 2310, converting html to text, auto tagging, topic modeling, part-of-speech (POS) tagging, clustering, and summarizing. Still in this embodiment, scrapped content 2308-2309, for example, text, images, and videos, are filtered by OCR 2307 and fed into a machine learning system for analysis and identification of key words, terms, and/or phrases 2311. In this particular embodiment, patterns are created 2312 based on the identified keywords and weights/ranks are assigned to the patterns 2313. Optionally, the patterns are further summarized and filtered 2314 so that they may be matched, in a modular fashion, to blocks 2315 within the web site skeleton based on weights and/or ranks assigned to the summarized patterns. In this particular embodiment, content are placed in the appropriate blocks on the webpage(s) in hierarchy 2316. The web page(s) in hierarchy are saved 2317 and temporary pages are deleted 2318. And the systems, methods, and media optionally go on to the next page URL 2319 to repeat the redesign process with machine learning, if needed.

In some cases, the redesigned web site includes one or more block modular as shown in the web site skeleton in FIG. 3. In further cases, the block modulars are placed on the web site or webpages in hierarchy. Such hierarchy may be determined and verified using the existing web site as shown in FIGS. 21-22. Alternatively, hierarchy may be determined and verified using a preselected third-party web site. In some cases, such hierarchy may be determined based on patterns identified and created using the extracted information of the existing web site. In some cases, extracted content may be placed in appropriate block(s). In some cases, each block includes one or more keywords associated with it. Such keywords may be weighted or ranked. In some cases, each block may contain different combinations of text and media as its content. Nonlimiting example of content includes: full-width text, text in multiple-columns, or text and images (in all kinds of orientations), video, text and video, slideshows, slideshows and text, or their combinations. In some cases, via usage of block modulars on a web site, various editing options are enabled in web site design and revision. For example, adding or deleting content within blocks, adding or deleting blocks modulars, changing the shape, appearance, or size of the block, and sorting blocks in various structures or hierarchies can be easily manageable without affecting the content therewithin. Thus, the block modulars make web site redesign efficient and convenient with great flexibility.

### Web Site Analysis and Reports

In some embodiments, the systems, methods, and media disclosed herein include a software module for analyzing the existing web site, analyzing the extracted content of the existing web site, or the like. In some cases, after analysis, a report is generated with a score card for the contents. In some cases, the score card comprises scores for different categories. Nonlimiting examples of categories include: search engine optimization (SEO), mobile compatibility, usability, and social media utilization.

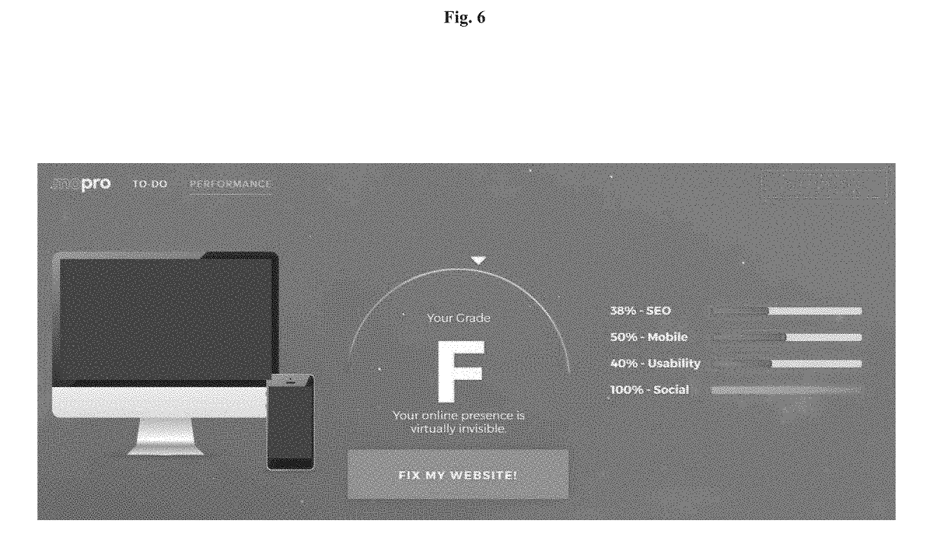

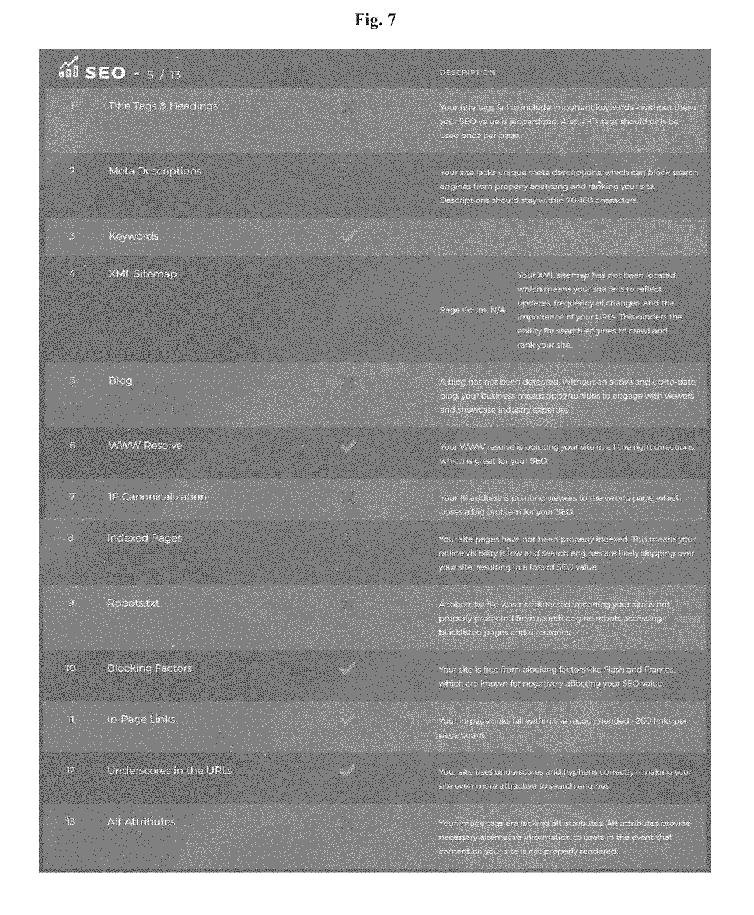

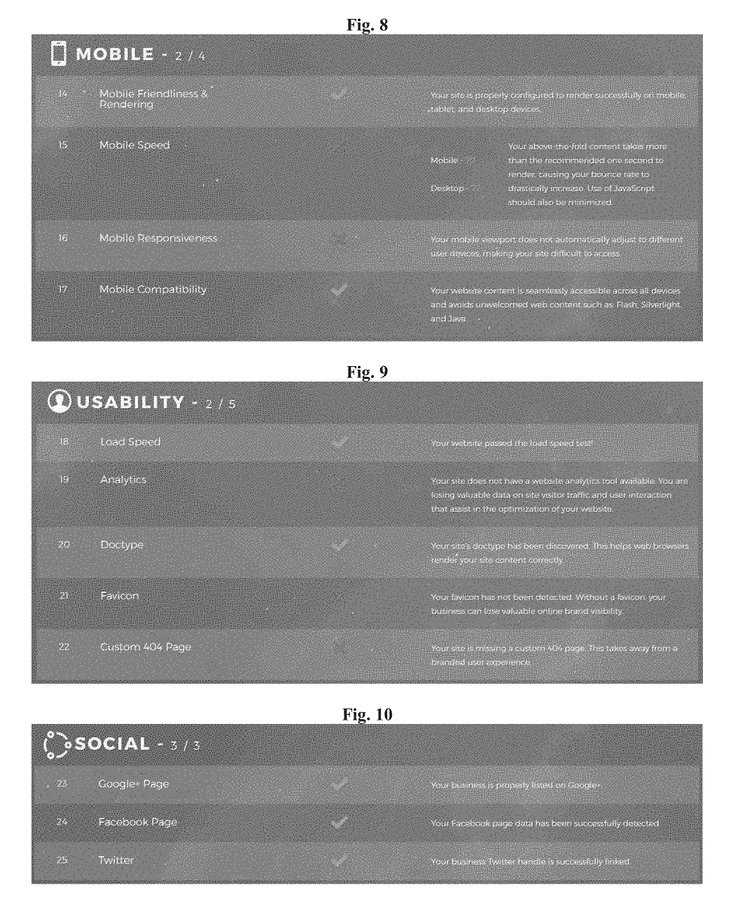

Referring to FIG. 6, in a particular embodiment, a user interface is presented to the user, optionally showing the web site entered by the user with a grade of the web site, and the scores for more than one different category that generates the grade of the web site. An access to start the design or rebuild of the web site is optionally provided at the user interface. In this particular embodiment, the categories includes: search engine optimization (SEO), mobile, usability, and social. In the same embodiment, each of the categories includes one or more subcategory as shown in FIGS. 7-10. In this embodiment, the user-provided web site is analyzed based on each category and sub-category, and a score is provided for each category or sub-category based on the analysis for presentation to the user at the user interface. The analysis criteria may be pre-determined or adjustable in different embodiments. Further, the score may be associated with a description of the sub-category, and a description of the detailed analysis. For example, as shown in FIG. 7, under the subcategory of “title tags and headings,” the analysis shows that “the title tags fail to include important keywords” so that the SEO value is jeopardized. The user interface may optionally present that only 5 of a total of 13 subcategories under SEO category pass the analysis and may not need redesign or improvements.

In certain embodiments, the web site analysis in categories provides a clear and easy-to-understand evaluation of the existing web site and it may be used as a reference so that the redesign process may focus on improving certain unsatisfactory categories or any categories that the user or web site owner selects. Thus, the web site analysis may be used to provide an objective for the business owner for improving or optimizing the existing web site. Similarly, it may also provide an objective for the automated redesign.

### User Preferences

In some cases, the user preferences are, at least in part, surveyed via a user dashboard interface, as shown in FIGS. 11, 14, and 15.

In some embodiments, the systems, methods, and media disclosed herein include one or more personas. In further cases, a persona is a client profile of the end consumer of the product. In some cases, a persona's attributes comprise demographics, psychographics, words, features, or value propositions that appeal to the group of end consumers.

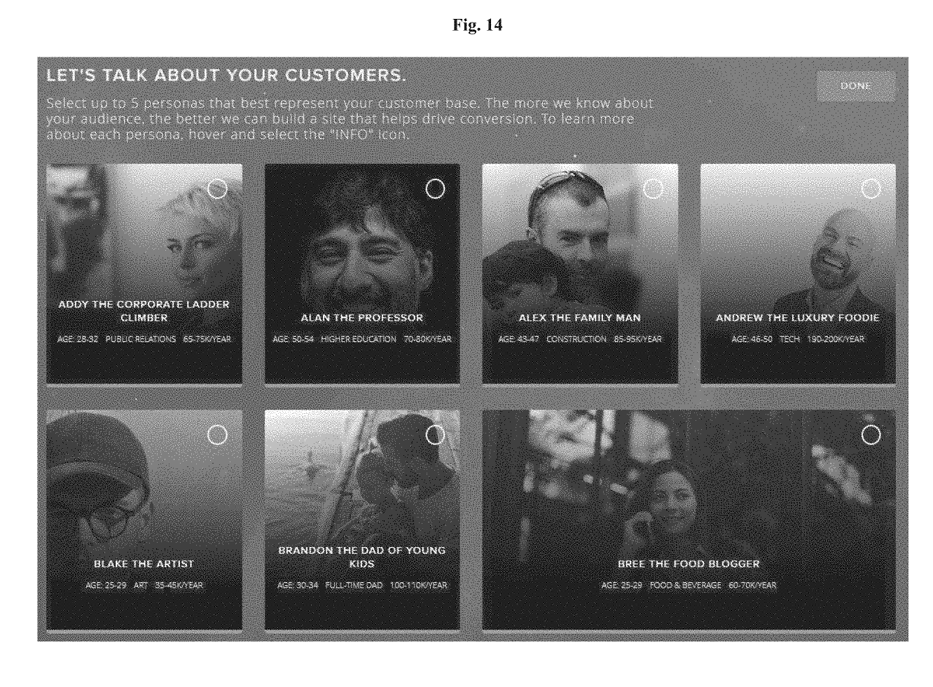

In some cases, the user is prompt to select one or more personas that represent his or her customer base, as shown in FIG. 14. In further cases, a list of pre-determined personas may be presented to the user for selection. In yet further cases, each persona may include a description, a picture, a video, or any other sensational presentations to the user. In alternative cases, the user is allowed to input personas manually or search personas using a search engine.

In some embodiments, the systems, methods, and media disclosed herein include a brand. In some cases, the brand is a company profile. In some cases, a brand's attributes comprises amount of content, amount of color, color style, font style, effect style, amount of animation, amount of effect, negative space, or the like.

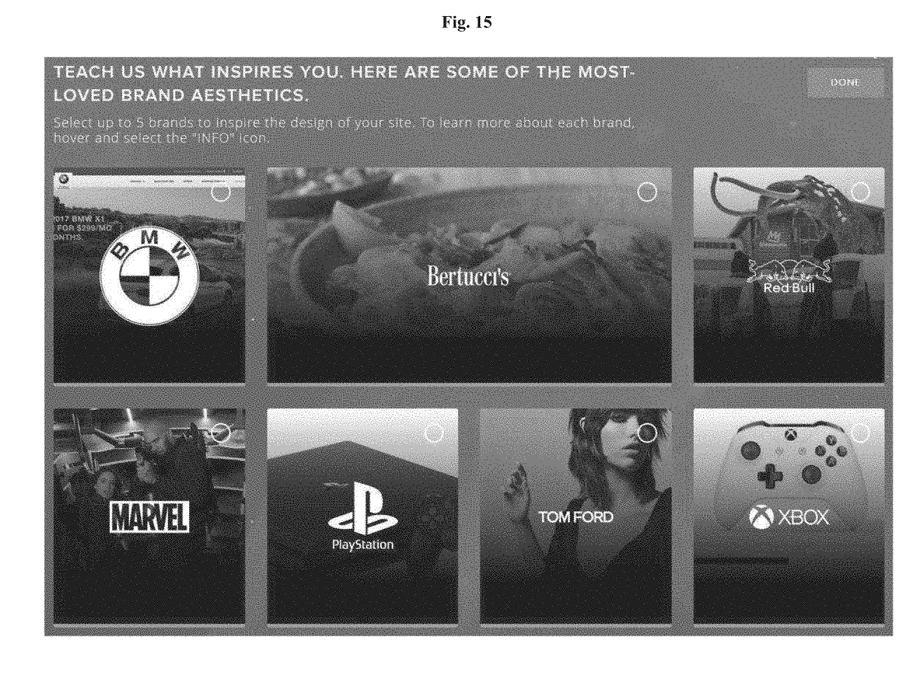

In some cases, the user is prompt to select one or more brands that are related to his or her business or product(s), as shown in FIG. 15. In some cases, the brand may be a brand that has a web site that is inspiring to the design of the user's web site. In some cases, the brand may be a competitor of the user's business. In some cases, the brand may have similar product(s) or share different end consumers with the user's business. In some case, the brand may be popular on the social media or featured in recent news. In some cases, the brand may be of particular interests to the user and the user's business/product(s). In further cases, a list of pre-determined brands may be presented to the user for selection. In yet further cases, each brand may include a description, a picture, a video, or any other sensational presentations to the user. In alternative case, the user is allowed to input brands manually or search brands using a search engine.

### Style Packages

In some embodiments, the systems, methods, and media disclosed herein include a style package or use of the same. In some cases, as shown in FIG. 1, the style package includes but is not limited to one or more color, font, image, video, background, animation, and effect for one or more elements of the web site.

In some cases, a style package may be selected with automatic selection of corresponding color(s), font(s), background(s), image(s), video(s), animation(s), and effect(s) to allow simple, fast, and easy-to-use web site design or redesign for a user. Alternatively, a user may choose to edit one or more aspects of a selected or pre-existing style package to further customize the web site design.

Moreover, the style package may be used in combination with brands and personas for optimal design of the user's web site as shown in FIG. 2. In some cases, the style features in the overlapped region of the three can be used for designing the web site. In other cases, a user may choose to use features from regions where any two of the three overlaps. As a result, the redesigned web site may not use all features provides in one or more preselected style packages or be limited by the features provides by one or more style packages. Instead, the redesigned web site may be further tailored to incorporate characteristic features from successful brand names that the user admires and/or utilize specific style elements that best attract a targeted audience. Such brand features or persona elements may or may not be included in any preselected style packages. If included in a preselected style package, then features that are not brand features and/or persona elements are optionally not used in the redesigned web site. If not included in a preselected style package, then the brand features or persona elements are optionally added to the package to be used in the redesigned web site. Such highly specialized combination of style preferences not only satisfies the user's need for a functional, easy-to-use, stylish, web site with high search engine optimization (SEO) value, but also renders each redesigned web site uniquely appealing to the targeted audience. As an example, a brand name of the user's interest includes an augmented reality rendering of its product, the augmented reality may not belong to any of the five categories as shown in FIGS. 1-2, and is not included in a preselected style package, but can be added to the preselected style package to be used in the web site redesign, and optionally creating a customized style package that can be saved and used later.

Web site skeletons

In some cases, the systems, methods, and media disclosed herein include a web site skeleton for web site redesign. In some cases, the web site skeleton has a plurality of hierarchical blocks. In further cases, the web site skeleton has one or more blocks filled with contents, one or more blocks partially filled, and one or more empty blocks. As an example, the web site skeleton may have a block filled with the business' name, contact information, which is either provided by the user or extracted from the existing web site.

In some cases, a web site skeleton may be selected from a plurality of preconfigured web site skeletons. Such preconfigured web site skeletons are optionally stored in a database. In other cases, a web site skeleton may be generated based on hierarchical information and/or layout information extracted from the existing web site. In some cases, manual editing may be applied to either preconfigured web site skeletons or generated web skeletons before the skeleton can be used for web site redesign.

Referring to FIGS. 32-36, in a particular embodiment, a skeleton layout with user provided information or information extracted from the user's existing web site is used as a starting point. In this embodiment, there is no design features or cascading style sheet (CSS) at the starting point. In some cases, the web site skeleton may include information entered by the user or extracted from the user's existing web site. For example, a web site skeleton may include a hierarchy of blocks; one of the blocks near the top of the hierarchy may be the business name and a founder's story entered by the user. As another example, the web site skeleton may include a block at the bottom of the hierarchy, which contains addresses of the business and a store locator.

In some cases, the web site skeleton serves as a starting point that style packages, user preferences, and content may be added to it to generate a web site. In some cases, the skeleton modular such that it may include pre-defined regions as shown in FIGS. 32-36, such as “testimonial,” “team,” etc, that can be populated with content and moved up or down in the hierarchy of the structure to suit the needs of a particular user. In some embodiments, a skeleton layout of webpages with hierarchy may be created using the ingested and extracted content of the existing web site. Such skeleton layout of webpages may include information that the user inputs. Further, such skeleton layout may include a hierarchy generated based on the ingested and extracted content of the existing web site.

In some cases, the web site skeleton may include a hierarchy directly derived from the existing web site, for example as shown in FIGS. 21-22. In some cases, the web site skeleton may include a hierarchy generated using a machine learning system and based on patterns generated using the extracted information of the existing web site as shown in FIG. 23.

### Machine Learning Systems

In some embodiments, the systems, methods, and media disclosed herein include a machine learning system or use of the same. An exemplary embodiment of the machine learning system herein is shown in FIG. 23. In some embodiments, systems, methods, and media disclosed herein include a software module for applying a machine learning system to rank/weight the extracted content and populating the content into the hierarchy of blocks based on the rank/weight. In some embodiments, the software module for applying a machine learning system to rank the extracted content utilizes a process comprising: removing HTML tags from the content; identifying keywords, key phrases, or both in the content; creating a plurality of patterns based on the keywords, key phrases, or both keywords and key phrases; and assigning a rank to each pattern.

In some cases, disclosed herein is a software module for populating the content into the hierarchy of blocks of the web site skeleton. In some cases, the software module for populating the content into the hierarchy of blocks utilizes a process comprising: creating a hierarchy of temporary webpages; populating each temporary page with content to generate a non-temporary page; and deleting each corresponding temporary page from the hierarchy.

In some cases, the machine learning system is used to automatically identify keywords, key phrases in the extracted content. In some cases, the machine learning system is used to create patterns based on key words or key phrases. In some cases, the machine learning system is used assign weights or ranks to the patterns. In some cases, such weights or ranks may be based on learning of one or more activities of user in editing the redesigned web site. In some cases, such weights or ranks may be based on learning of one or more activities of the user in social accounts. In some cases, such weights or ranks may be based on information extracted from the existing web site, a third-party web site, or directly provided by the user. In some cases, the machine learning system is used to assign blocks based on weights to summarized patterns. In some cases, the machine learning system is used to generate the hierarchy of blocks or webpages.

In some cases, the extraction and analysis of existing web site and its content using a machine learning system herein may generate information of a webpage or content therewithin with respect to its importance, quality, or relevance to the existing web site, a webpage of the existing web site, or the web site to be redesigned. And the importance, quality, and relevance of the content, for instances, is useful for web site redesign with selected content in hierarchy. In some cases, text, images, videos, and information of other forms are analyzed to determine if they should be included in the redesigned web site or not, which block(s) should they be included in, and where should they be positioned in the hierarchy of block modulars on the redesigned website. For example, text may be analyzed based on its font size, color, location on the web page, or other related aspects to determine if it is regarded as prominent information. In some case, information may be ranked, weighed, or labeled for different prominence or priority based on the analysis. Further, the text may be analyzed for quality of its content, such as how detailed it is, how concise it is, is it useful for a certain block modular, etc to facilitate determination of its importance and relevance. Similarly, an image, a video, or other type of files may be analyzed by a computer vision algorithm or similar algorithms to determine its importance or relevance to certain categories. For example, an image may be a picture of a product, a testimonial, or a team member, so that it can be populated into a corresponding block modular of the redesigned website. As another example, the quality and contrast of an image may be very high as it is a featured product of the user's business, thus, this image should be placed relatively high in the hierarchy to attract enough attention from the customers.

In some cases, the machine learning system uses extracted content of the existing web site as its input. In some cases, the machine learning system uses scrapped content as input. In some cases, the machine learning system uses the user's input, and/or the user's activities with redesigned web site, the web site skeleton, the style package, the brands, the personas, or other elements disclosed herein as its input. In some cases, the machine learning system utilizes its input(s) to generate a model with model parameters that learns and predicts the user's activities and preferences so that such learned preferences of the user may be incorporated into the redesigned web site. As an example, the machine learning system may monitor the user's editing at the user interface and predicts that the user likes to use cartoon images and videos throughout his or her web site. As another example, the machine learning system may monitor the user's updates over time and predicts that the user prefer to feature latest update of his products at the top of his web site.

In some cases, the machine learning system utilizes its input(s) to generate a model with model parameters that learns and predicts the characteristics of the existing web site so that such learned characteristics of the web site may be incorporated into the redesigned web site. As an example, the machine learning system may summarize all the colors used in the existing web site and predicts the most popular colors that the user might like. As another example, the machine learning system may learn and predict that the user likes to present testimonials in media rather than in plain text on her web site.

In some cases, the machine learning system utilizes its input(s) to generate a model with model parameters that learns and predicts the preferences of the user based on information obtained from his social media account(s) and activities.

In some case, the machine learning system may include one or more of: a statistical algorithm, an empirical algorithm, an artificial intelligence algorithm, a deep-learning algorithm, or the like.

### Automated Web Site Generation

In some cases, the systems, methods, and media herein include a software module for automatically generating a redesigned web site by applying the style package to the populated web site skeleton as shown in FIGS. 3, 32-36. In some cases, the software module for automatically generating a redesigned web site generates multiple versions of the web site suitable for mobile devices, or other digital devices.

Referring to FIG. 11, in a particular embodiment, the user may be prompt at a dashboard to tailor his or her own web site by completing one or more categories. In some cases, the categories may include one or more of: basic information of the user or the user's business, value propositions of the user or the user's business, colors to be used, testimonials, photos, videos, fonts, social posting schedules personas, and brands that the user selects based on his or her business and end consumer of his or her product(s). In this embodiment, the user is provided with an access to start building the customized web site after the user enters information for one or more categories.

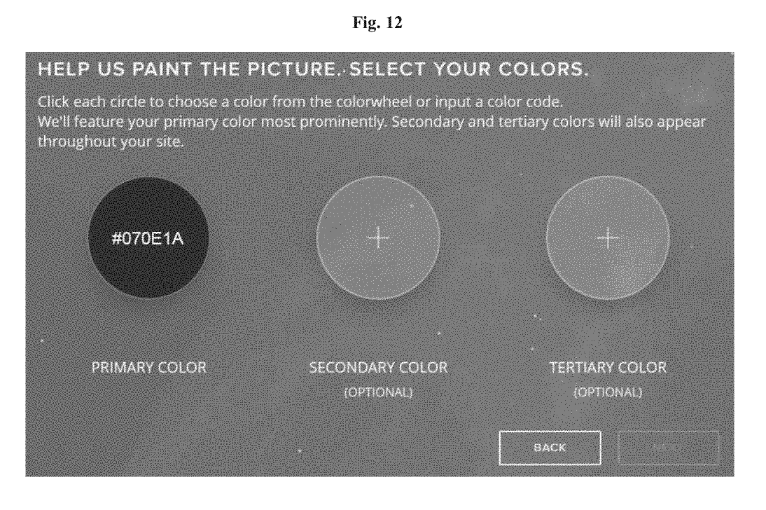

In some embodiments, the user is prompt to select one or more colors or input a color code at a user interface, for example, as in FIG. 12.

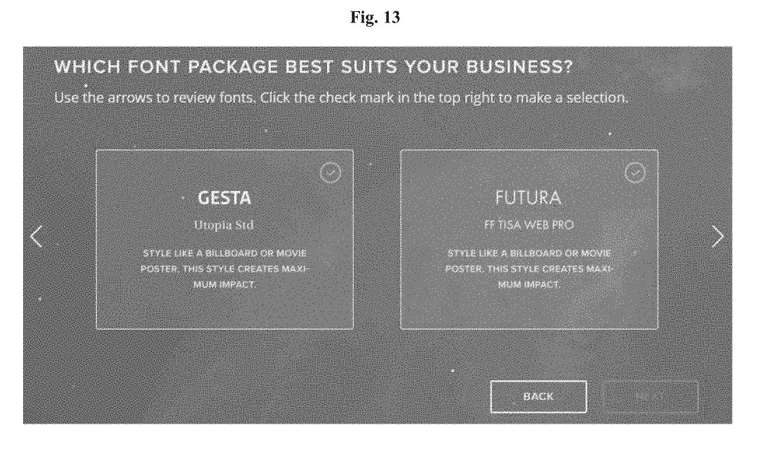

In some embodiments, the user is prompt to select one or more font at a user interface, for example, as in FIG. 13.

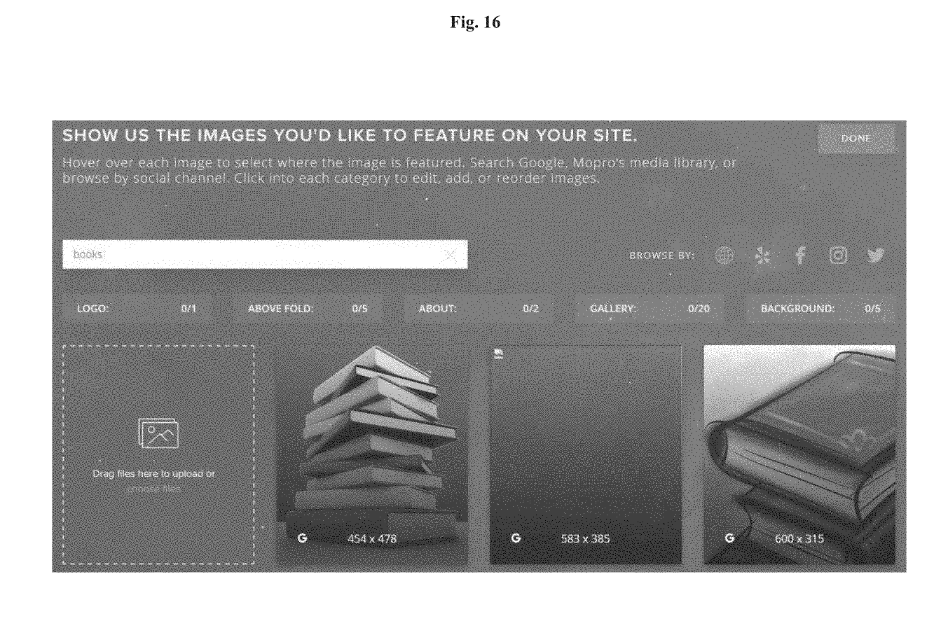

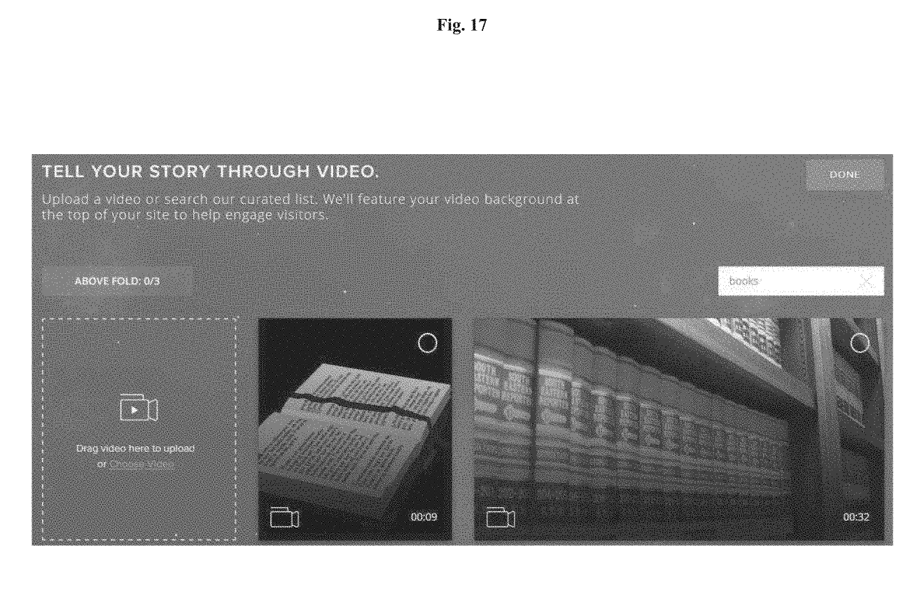

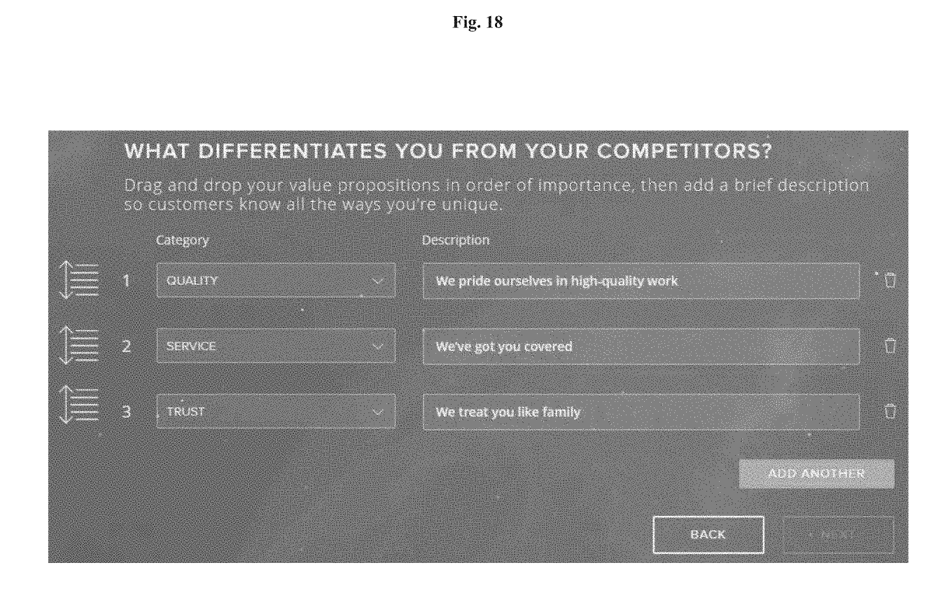

In some embodiments, the user is prompt to select one or more images or videos at a user interface, for example, as in FIGS. 16-17. The user may select the image(s) or videos in different categories. Such images or videos for selection may be extracted from different online sources or saved in a database.

For instances, the user is prompt to select one or more value propositions at a user interface, for example, as shown in FIG. 18. In some cases, the value propositions are selected in an order of the importance. A description may be added for each of the value propositions by the user.

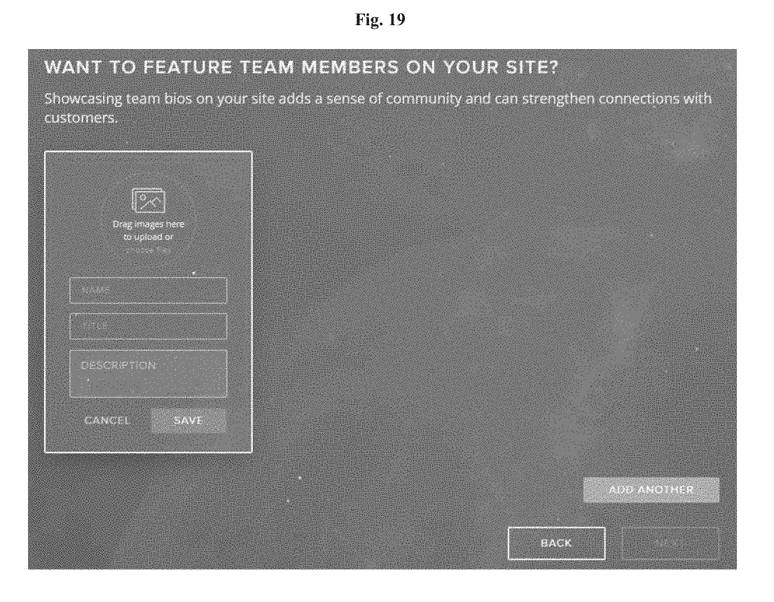

In some embodiments, the user is prompt to enter information of one or more team members at a user interface, for example, as in FIG. 19.

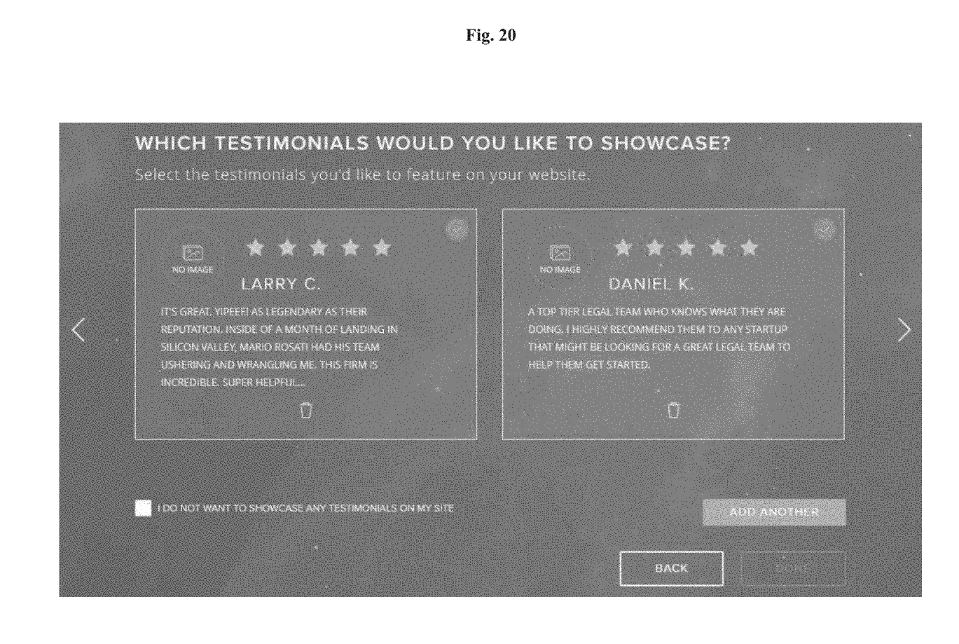

In some embodiments, the user is prompt to enter testimonials at a user interface, for example, as in FIG. 20.

### Interface for Editing

In some embodiments, the systems, media, and methods described herein include a user interface that allows a user to view and edit the redesigned web site, which includes but are not limited to the style package, the content, and the web site skeleton.

In some cases, the interface comprises tools for previewing the redesigned web site on a plurality of devices. In some cases, the user may view the redesigned web site in its customer's version. In some cases, the user may edit the redesigned web site in is customer's version or alternatively in a web site owner's version. In some cases, the user may interact with individual elements or a combination of elements of the redesigned web site at the user interface to change position, appearance, color, and/or font, replace it with a new element, edit its content, and/or apply any other possible changes. For example, a user may compare different color schemes in the redesigned web site, and selects one among different color schemes. As another example, the user may edit the content in the block of “news” related to the business monthly or weekly with updates. As another example, the user may replace an outdated video with a new three-dimensional video. As yet another example, the user may change a position of a block in the hierarchy of the webpages.

In some cases, the interaction of the user with elements at the interface may be via an input device, examples of input devices includes but are not limited to a keyboard, a mouse, a joystick, a touch screen, a sensor, or the like. As nonlimiting examples, the user may contact, drag, move, click, double click, circle, check, swipe, point the elements using the input device in order to edit it.

### Automated Social Media Activity

In some embodiments, the systems, media, and methods described herein include a software module and/or interface for configuring automated social media activities. Such automated social media activities, for example, automated blogging or posting, provides a tool for the owner of the web site to showcase the products, news, or other information of his or her business or product to the customers and/or other parties in order to attract more traffic to the web site.

In some cases, the software module for configuring automated social media activity allows the user to configure a type of content and a frequency of activity. In some cases, the software module for configuring automated social media activity presents a calendar schedule of automated social media activity. In some cases, such types of content selected by the user may be used as information of the user's preferences for future web site redesign.

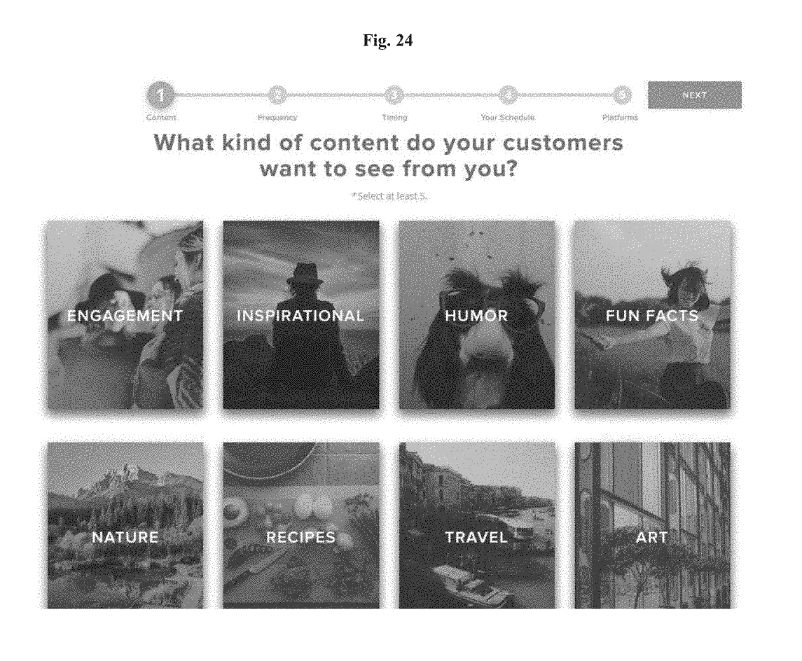

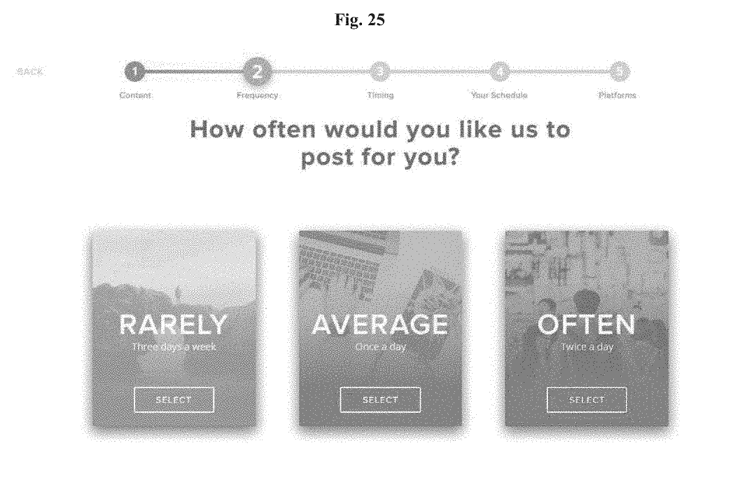

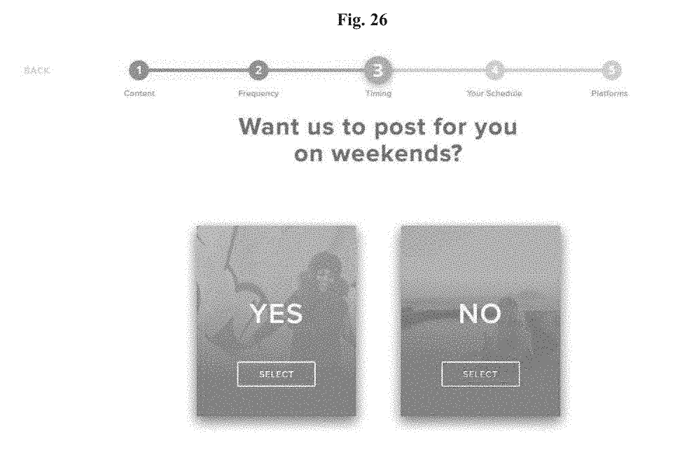

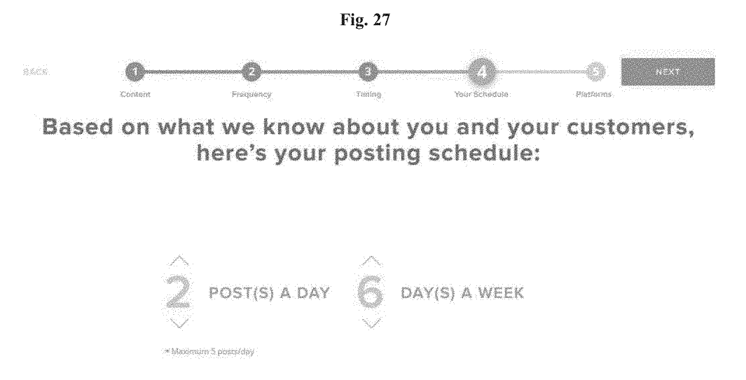

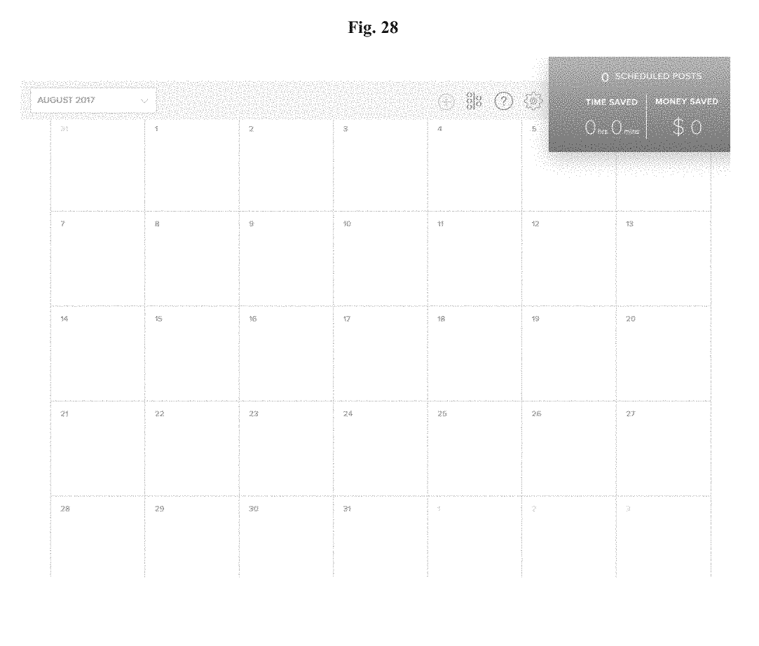

Referring to FIGS. 24-28, in a particular embodiment, a user interface may be provided to the user to allow the user to schedule automated social posting of his or her web site. In this embodiment, the user is prompt to select content to be posted on social media web sites, as shown in FIG. 24. Such content may be selected from pre-determined categories or manually entered by the user. In the same embodiment, the user is then prompt to select frequency and timing of social posting, as shown in FIGS. 25-26. Afterwards, the platforms, systems, media, and methods described herein optionally recommends a social posting schedule for the user based on the customer of the user, optionally in combination with other information about the user and the user's business. Referring to FIG. 28, a customized social posting schedule, with or without costs is presented to the user.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected to a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

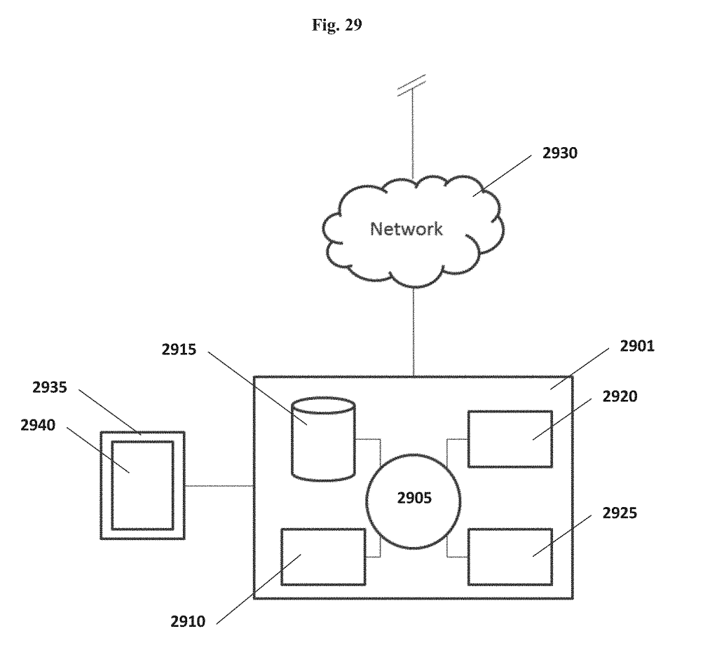

Referring to FIG. 29, in a particular embodiment, an exemplary digital processing device 2901 is programmed or otherwise configured to generate a redesigned web site. The device 2901 can regulate various aspects of content ingestion, extraction, and analysis, or style and skeleton selection, or population, generation, and preview, or editing of the present disclosure. In this embodiment, the digital processing device 2901 includes a central processing unit (CPU, also “processor” and “computer processor” herein) 2905, which can be a single core or multi core processor, or a plurality of processors for parallel processing. The digital processing device 2901 also includes memory or memory location 2910 (e.g., random-access memory, read-only memory, flash memory), electronic storage unit 2915 (e.g., hard disk), communication interface 2920 (e.g., network adapter) for communicating with one or more other systems, and peripheral devices 2925, such as cache, other memory, data storage and/or electronic display adapters. The memory 2910, storage unit 2915, interface 2920 and peripheral devices 2925 are in communication with the CPU 2905 through a communication bus (solid lines), such as a motherboard. The storage unit 2915 can be a data storage unit (or data repository) for storing data. The digital processing device 2901 can be operatively coupled to a computer network (“network”) 2930 with the aid of the communication interface 2920. The network 2930 can be the Internet, an internet and/or extranet, or an intranet and/or extranet that is in communication with the Internet. The network 2930 in some cases is a telecommunication and/or data network. The network 2930 can include one or more computer servers, which can enable distributed computing, such as cloud computing. The network 2930, in some cases with the aid of the device 2901, can implement a peer-to-peer network, which may enable devices coupled to the device 2901 to behave as a client or a server.

Continuing to refer to FIG. 29, the CPU 2905 can execute a sequence of machine-readable instructions, which can be embodied in a program or software. The instructions may be stored in a memory location, such as the memory 2910. The instructions can be directed to the CPU 2905, which can subsequently program or otherwise configure the CPU 2905 to implement methods of the present disclosure. Examples of operations performed by the CPU 2905 can include fetch, decode, execute, and write back. The CPU 2905 can be part of a circuit, such as an integrated circuit. One or more other components of the device 2901 can be included in the circuit. In some cases, the circuit is an application specific integrated circuit (ASIC) or a field programmable gate array (FPGA).

Continuing to refer to FIG. 29, the storage unit 2915 can store files, such as drivers, libraries and saved programs. The storage unit 2915 can store user data, e.g., user preferences and user programs. The digital processing device 2901 in some cases can include one or more additional data storage units that are external, such as located on a remote server that is in communication through an intranet or the Internet.

Continuing to refer to FIG. 29, the digital processing device 2901 can communicate with one or more remote computer systems through the network 2930. For instance, the device 2901 can communicate with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants.

Methods as described herein can be implemented by way of machine (e.g., computer processor) executable code stored on an electronic storage location of the digital processing device 2901, such as, for example, on the memory 2910 or electronic storage unit 2915. The machine executable or machine readable code can be provided in the form of software. During use, the code can be executed by the processor 2905. In some cases, the code can be retrieved from the storage unit 2915 and stored on the memory 2910 for ready access by the processor 2905. In some situations, the electronic storage unit 2915 can be precluded, and machine-executable instructions are stored on memory 2910.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

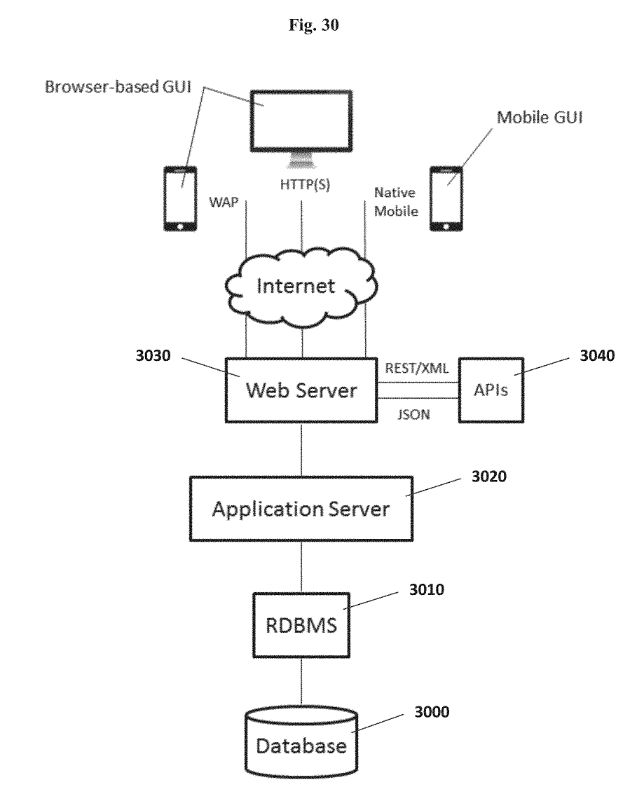

Referring to FIG. 30, in a particular embodiment, an application provision system comprises one or more databases 3000 accessed by a relational database management system (RDBMS) 3010. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 3020 (such as Java servers, .NET servers, PHP servers, and the like) and one or more web servers 3030 (such as Apache, IIS, GWS and the like). The web server(s) optionally expose one or more web services via app application programming interfaces (APIs) 3040. Via a network, such as the Internet, the system provides browser-based and/or mobile native user interfaces.

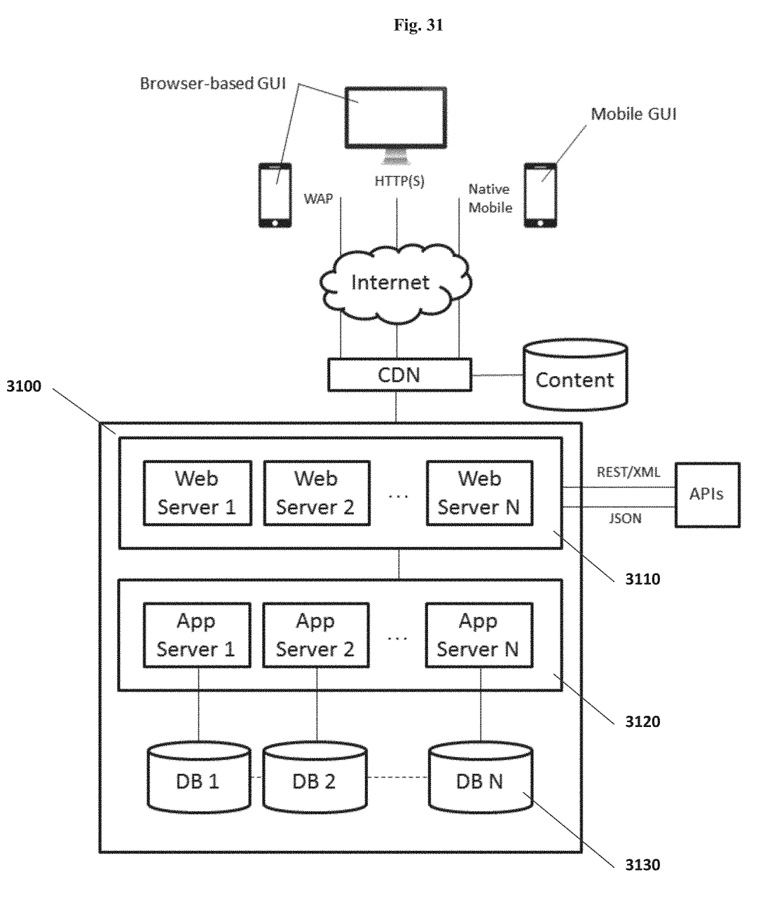

Referring to FIG. 31, in a particular embodiment, an application provision system alternatively has a distributed, cloud-based architecture 3100 and comprises elastically load balanced, auto-scaling web server resources 3110 and application server resources 3120 as well synchronously replicated databases 3130.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user entered information, extracted content, URLs, images, videos, text, effects, animations, fonts, colors, style packages, personas, brands, web site skeletons, and/or machine learning algorithms. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

While preferred embodiments of the present subject matter have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the subject matter described herein may be employed in practicing the invention.

1. A computer-implemented system comprising: a digital processing device comprising: at least one processor, an operating system configured to perform executable instructions, a memory, and a computer program including instructions executable by the digital processing device to create an intelligent web presence redesign application comprising:
a) a software module for ingesting files of an existing web site;
b) a software module for extracting content from the ingested files;
c) a software module for surveying a user for user preferences to determine a style package and select a web site skeleton from a plurality of preconfigured web site skeletons, the web site skeleton having a plurality of hierarchical blocks;
d) a software module for applying a machine learning system to rank the extracted content and populating the content into the hierarchy of blocks based on the rank;
e) a software module for automatically generating a redesigned web site by applying the style package to the populated web site skeleton; and
f) a software module for providing an interface allowing the user to edit the style package, the content, and the web site skeleton.

2. The system of claim 1, wherein the software module for ingesting files of an existing web site allows the user to input a URL for the existing web site.

3. The system of claim 1, wherein the software module for extracting the content from the ingested files utilizes a site map or a navigation menu of the existing web site.

4. (canceled)

5. The system of claim 1, wherein the software module for extracting content from the ingested files filters content by optical character recognition (OCR).

6. The system of claim 1, wherein the software module for extracting content from the ingested files filters content by image recognition.

7. The system of claim 1, wherein the application further comprises a software module for analyzing the extracted content to generate a score card for the content.

8. The system of claim 7, wherein the score card comprises scores for search engine optimization (SEO), mobile compatibility, usability, social media utilization, or a combination thereof.

9. The system of claim 1, wherein the user preferences comprise at least one brand admired by owner of the existing web site.

10. The system of claim 9, wherein the at least one brand is associated with a preconfigured amount of content, amount of color, amount of negative space, font style, or a combination thereof.

11. The system of claim 1, wherein the user preferences comprise at least one persona selected by the owner of the existing web site as reflective of current users.

12. The system of claim 11, wherein the at least one persona is associated with preconfigured demographics, psychographics, words, value propositions, or a combination thereof.

13. The system of claim 1, wherein the style package comprises: effects, fonts, images, videos, backgrounds, colors, animations, or a combination thereof.

14. The system of claim 1, wherein the user preferences are, at least in part, surveyed via a user dashboard interface.

15. The system of claim 1, wherein the software module for applying a machine learning system to rank the extracted content utilizes a process comprising:
a) removing HTML tags from the content;
b) identifying keywords, keyphrases, or both keywords and keyphrases in the content;
c) creating a plurality of patterns based on the keywords, keyphrases, or both keywords and keyphrases; and
d) assigning a rank to each pattern.

16. The system of claim 1, wherein the software module for populating the content into the hierarchy of blocks utilizes a process comprising:
a) creating a hierarchy of temporary pages;
b) populating each temporary page with content to generate a non-temporary page; and
c) deleting each corresponding temporary page from the hierarchy.

17. The system of claim 1, wherein the application further comprises a software module for configuring automated social media activity.

18. The system of claim 17, wherein the software module for configuring automated social media activity allows the user to configure a type of content and a frequency of activity.

19. The system of claim 17, wherein the software module for configuring automated social media activity presents a calendar schedule of the automated social media activity.

20. The system of claim 17, wherein the software module for automatically generating a redesigned web site generates multiple versions of the web site, wherein at least one version is a mobile version.

21. The system of claim 17, wherein the interface allowing the user to edit the style package, the content, and the web site skeleton comprises tools for previewing the redesigned web site on a plurality of devices.

22. Non-transitory computer-readable storage media encoded with a computer program including instructions executable by a processor to create an intelligent web presence redesign application comprising:
a) a software module for ingesting files of an existing web site;
b) a software module for extracting content from the ingested files;
c) a software module for surveying a user for user preferences to determine a style package and select a web site skeleton from a plurality of preconfigured web site skeletons, the web site skeleton having a plurality of hierarchical blocks;
d) a software module for applying a machine learning system to rank the extracted content and populating the content into the hierarchy of blocks based on the rank;
e) a software module for automatically generating a redesigned web site by applying the style package to the populated web site skeleton; and
f) a software module for providing an interface allowing the user to edit the style package, the content, and the web site skeleton.

23.-42. (canceled)

43. A computer-implemented method for automated intelligent web presence redesign comprising:
a) ingesting files of an existing web site;
b) extracting content from the ingested files;
c) surveying a user for user preferences;
d) determining a style package based on the user preferences;
e) selecting a web site skeleton from a plurality of preconfigured web site skeletons based on the user preferences, the web site skeleton having a plurality of hierarchical blocks;
f) applying a machine learning system to rank the extracted content;
g) populating the content into the hierarchy of blocks based on the rank;
h) automatically generating a redesigned web site by applying the style package to the populated web site skeleton; and
i) providing an interface allowing the user to edit the style package, the content, and the web site skeleton.

44-63. (canceled)
